(19) United States
(12) Patent Application Publication
(10) Pub. No.: US 2023/0011475 A1
(43) Pub. Date: Jan. 12, 2023

(54) OBJECT RECOGNITION DEVICE AND OBJECT RECOGNITION METHOD

(71) Applicant: Mitsubishi Electric Corporation, Tokyo (JP)

(72) Inventors: Masanori MORI, Tokyo (JP); Koji IIDA, Tokyo (JP); Shinichi TATEIWA, Tokyo (JP)

(73) Assignee: Mitsubishi Electric Corporation, Tokyo (JP)

(21) Appl. No.: 17/778,243

(22) PCT Filed: Nov. 29, 2019
(86) PCT No.: PCT/JP2019/046807

§ 371 Date: May 19, 2022

(51) Int. Cl. G01S 13/931; G08G 1/16; G01S 13/58; G01S 17/42; G01S 7/4865; G01S 17/931

(52) U.S. Cl. CPC G01S 13/931; G08G 1/16; G01S 13/584; G01S 17/42; G01S 7/4865; G01S 17/931; G06V 20/58

(57) ABSTRACT

Provided is an object recognition device including a prediction processing unit, a temporary setting unit, and a association processing unit. The prediction processing unit predicts, as a prediction position on an object model obtained by modeling a tracking target, a position of a movement destination of the tracking target based on a trajectory formed by movement of at least one object of a plurality of objects as the tracking target. The temporary setting unit sets, based on specifications of a sensor that has detected the tracking target, a position of at least one candidate point on the object model. The association processing unit sets, based on the position of the candidate point and the prediction position, a reference position on the object model. The association processing unit determines whether the position of the detection point and the prediction position associate with each other based on a positional relationship between a association range which is set so that the association range has a reference position on the object model as a reference and a detection point at a time when the sensor has detected the at least one object of the plurality of objects.

### TECHNICAL FIELD

The present invention relates to an object recognition device and an object recognition method.

### BACKGROUND ART

Hitherto, there has been known an object recognition device which fits, to a shape model of an object, a position of a detection point at a time when a sensor has detected the object, and identifies a position of a track point forming a track of the object based on the position of the detection point on the shape model of the object (for example, see Patent Literature 1).

### CITATION LIST

### Patent Literature

[PTL 1] JP 2017-215161 A

### SUMMARY OF INVENTION

### Technical Problem

It has been known that the object recognition device as described in Patent Literature 1 determines whether or not a position of a movement destination of the object and the position of the detection point associate with each other based on whether or not the position of the detection point is included in a association range which is set around the position of the movement destination of the object as a center.

However, in the related-art object recognition device as described in Patent Literature 1, the association range may not accurately be set depending on resolution of the sensor. In such a case, there is a fear in that an error may occur in the determination of whether or not the position of the movement destination of the object and the position of the detection point associate with each other. Thus, precision of the track data on the object indicating the position of the track point of the object decreases.

The present invention has been made in order to solve the above-mentioned problem, and has an object to provide an object recognition device and an object recognition method which are capable of increasing precision of track data on an object.

### Solution to Problem

According to one embodiment of the present invention, there is provided an object recognition device including: a prediction processing unit configured to predict, as a prediction position on an object model obtained by modeling a tracking target, a position of a movement destination of the tracking target based on a trajectory formed by movement of at least one object of a plurality of objects as the tracking target; a temporary setting unit configured to set, based on specifications of a sensor that has detected the tracking target, a position of at least one candidate point on the object model; and a association processing unit configured to identify a reference position on the object model based on the position of the at least one candidate point and the prediction position, and to determine, based on a positional relationship between a association range which is set so that the association range has the reference position on the object model as a reference and a detection point at a time when the sensor has detected the at least one object of the plurality of objects, whether the position of the detection point and the prediction position associate with each other.

### Advantageous Effects of Invention

According to the object recognition device of the present invention, it is possible to increase the precision of the track data on the object.

### BRIEF DESCRIPTION OF DRAWINGS

FIG. 1 is a block diagram for illustrating a functional configuration example of a vehicle control system in an embodiment of the present invention.

FIG. 2 is a diagram for illustrating an example of a relative positional relationship between a sensor of FIG. 1 and objects.

FIG. 3 is a diagram for illustrating an example of a candidate point being a first candidate of a position of a detection point on a vehicle of FIG. 2.

FIG. 4 is a diagram for illustrating an example of a candidate point being a second candidate of the position of the detection point on the vehicle of FIG. 2.

FIG. 5 is a diagram for illustrating an example of a candidate point being another candidate of a detection point on a vehicle.

FIG. 6 is a graph for showing a setting example of a reliability of the candidate points of FIG. 3 to FIG. 5 where N is a natural number.

FIG. 7 is a diagram for illustrating an example of prediction data of FIG. 1.

FIG. 8 is a diagram for illustrating an example of a reference position identified based on a prediction position of the prediction data of FIG. 7 and a candidate point.

FIG. 9 is a diagram for illustrating a first setting example of a association range set by using the reference position of FIG. 8 as a reference.

FIG. 10 is a diagram for illustrating a second setting example of the association range set by using the reference position of FIG. 8 as the reference.

FIG. 11 is a diagram for illustrating a third setting example of the association range set by using the reference position of FIG. 8 as the reference.

FIG. 12 is a diagram for illustrating an example in which a direction is further included in the track data of FIG. 7.

FIG. 13 is a diagram for illustrating an example in which a height is further included in the track data of FIG. 7.

FIG. 14 is a diagram for illustrating an example in which a position of an upper end and a position of a lower end are further included in the track data of FIG. 7.

FIG. 15 is a diagram for schematically illustrating an overlap of a determination target object model of a association determination target having the position of the detection point of FIG. 2 as a center with an object model of a tracking target having a prediction position of FIG. 8 as a center.

FIG. 16 is a flowchart for illustrating processing executed by the object recognition device of FIG. 1.

FIG. 17 is a flowchart for illustrating association relating processing executed in Step S19 of FIG. 16.

FIG. 18 is a flowchart for illustrating association range setting processing executed in Step S38 of FIG. 17.

FIG. 19 is a flowchart for illustrating association determination processing executed in Step S20 of FIG. 16.

FIG. 20 is a flowchart for illustrating validity determination processing executed in Step S75 of FIG. 19.

FIG. 21 is a diagram for illustrating a hardware configuration example.

FIG. 22 is a diagram for illustrating another hardware configuration example.

### DESCRIPTION OF EMBODIMENTS

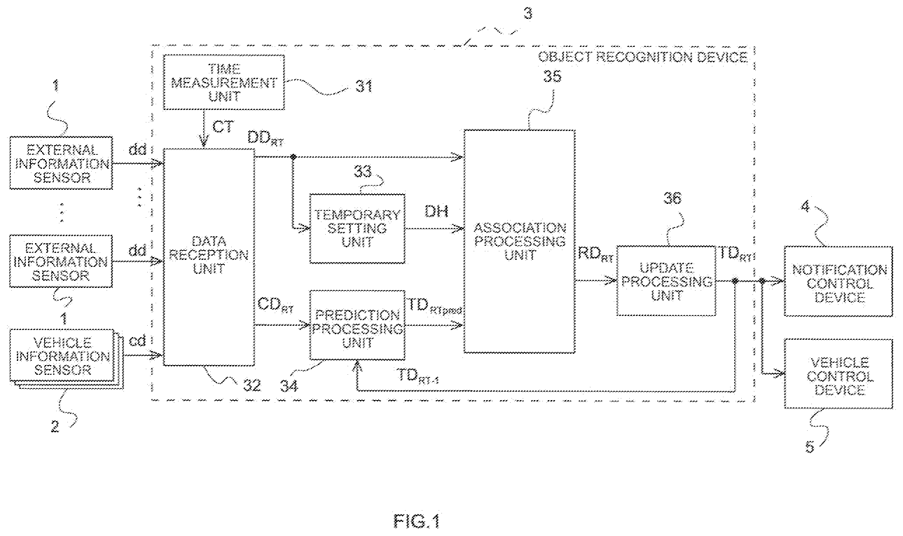

FIG. 1 is a block diagram for illustrating a functional configuration example of a vehicle control system in an embodiment of the present invention. As illustrated in FIG. 1, the vehicle control system includes a plurality of external information sensors 1, a plurality of vehicle information sensors 2, an object recognition device 3, a notification control device 4, and a vehicle control device 5.

Each of the plurality of external information sensors 1 is mounted to an own vehicle. For example, a part of the external information sensors 1 of the plurality of external information sensors 1 are individually mounted to an inside of a front bumper, an inside of a rear bumper, and a cabin side of a windshield. For the external information sensor 1 mounted to the inside of the front bumper, objects that exist forward or sideward of a vehicle C are set as objects to be observed. For the external information sensor 1 mounted to the inside of the rear bumper, objects that exist backward or sideward of the vehicle C are set as objects to be observed.

Moreover, the external information sensor 1 mounted on the cabin side of the windshield is arranged next to an inner rearview mirror. For the external information sensor 1 mounted next to the inner rear view mirror on the cabin side of the windshield, objects that exist forward of the vehicle C are set as objects to be observed.

Thus, each of the plurality of external information sensors 1 mounted to the own vehicle is a sensor capable of acquiring, as detection data dd, the information on the objects around the own vehicle. The respective pieces of detection data dd on the objects around the own vehicle acquired by the plurality of external information sensors 1 are integrated into and generated as detection data DD. The detection data DD is generated to have a data configuration that can be supplied to the object recognition device 3. The detection data DD includes at least one piece of information on a position P of at least one detection point DP.

The external information sensor 1 observes an object by detecting any point on a surface of the object as a detection point DP. Each detection point DP indicates each point on the object observed by the external information sensor 1 around the own vehicle. For example, the external information sensor 1 irradiates light as irradiation light around the own vehicle, and receives reflected light reflected on each reflection point on the object. Each reflection point corresponds to each detection point DP.

Moreover, the information on the object that can be measured at the detection point DP varies depending on a measurement principle of the external information sensor 1.

As types of the external information sensors 1, a millimeter wave radar, a laser sensor, an ultrasonic sensor, an infrared sensor, a camera, and the like can be used. Description of the ultrasonic sensor and the infrared sensor is omitted.

The millimeter wave radar is mounted to, for example, each of the front bumper and the rear bumper of the own vehicle. The millimeter wave radar includes one transmission antenna and a plurality of reception antennas. The millimeter wave radar can measure a distance and a relative speed to an object. The distance and the relative speed to the object are measured by, for example, a frequency modulation continuous wave (FMCW) method. Thus, the position P of the detection point DP and the speed V of the detection point DP can be observed based on the distance and the relative speed to the object measured by the millimeter wave radar.

In the following description, the speed V of the detection point DP may be the relative speed between the own vehicle and the object, or may be a speed with respect to an absolute position acquired by further using the GPS.

The millimeter wave radar can measure an azimuth angle of the object. The azimuth angle of the object is measured based on phase differences among the respective radio waves received by the plurality of reception antennas. Thus, a direction θ of the object can be observed based on the azimuth angle of the object measured by the millimeter wave radar.

As described above, with the millimeter wave radar, there can be observed, as the information on the object, the detection data DD including the speed V of the detection point DP and the direction θ of the object in addition to the position P of the detection point DP. Of the position P of the detection point DP, the speed V of the detection point DP, and the direction θ of the object, each of the speed V of the detection point DP and the direction θ of the object is a dynamic element for identifying a state of the object. Each of those dynamic elements is an object identification element.

When the relative speed to the object is measured, the millimeter wave radar of the FMCW type detects a frequency shift caused by the Doppler effect between a frequency of a transmission signal and a frequency of a reception signal, that is, the Doppler frequency. The detected Doppler frequency is proportional to the relative speed to the object, and the relative speed can thus be derived from the Doppler frequency.

Moreover, speed resolution of the millimeter wave radar is determined by resolution of the Doppler frequency. The resolution of the Doppler frequency is a reciprocal of an observation period of the reception signal. Thus, as the observation period increases, the resolution of the Doppler frequency increases. Thus, as the observation period increases, the speed resolution of the millimeter wave radar increases.

For example, in a case in which the own vehicle is traveling on an expressway, the observation period of the millimeter wave radar is set to be longer compared with a case in which the own vehicle is traveling on a general road. Consequently, the speed resolution of the millimeter wave radar can be set to be high. Thus, in the case in which the own vehicle is traveling on an expressway, a change in the speed can be observed earlier compared with the case in which the own vehicle is traveling on a general road. Consequently, objects around the own vehicle can be observed earlier.

Moreover, distance resolution of the millimeter wave radar is defined as a division of the light speed divided by a modulation frequency band width. Thus, as the modulation frequency band width increases, the distance resolution of the millimeter wave radar increases.

For example, in a case in which the own vehicle is traveling in a parking lot, the modulation frequency band width is set to be wider compared with the case in which the own vehicle is traveling on a general road or an expressway. Consequently, the distance resolution of the millimeter wave radar can be set to be high. In a case in which the distance resolution of the millimeter wave radar is set to be high, the detectable minimum unit distance around the own vehicle is short, and thus it is possible to distinguish objects existing side by side from each other.

For example, when a pedestrian and the vehicle C exist as the objects around the own vehicle, there is brought about a state in which there simultaneously exist the pedestrian having low reflection intensity to the electromagnetic wave irradiated from the millimeter wave radar and the vehicle C having high reflection intensity thereto. Even under this state, the electromagnetic wave reflected from the pedestrian is not absorbed by the electromagnetic wave reflected from the vehicle C, and the pedestrian can thus be detected.

The laser sensor is mounted to, for example, an outside of a roof of the own vehicle. As the laser sensor, for example, a light detection and ranging (LIDAR) sensor is mounted to the outside of the roof of the own vehicle. The LIDAR sensor includes a plurality of light emitting units, one light receiving unit, and a calculation unit. The plurality of light emitting units are arranged at a plurality of angles with a perpendicular direction with respect to a forwarding travel direction of the own vehicle.

A time of flight (TOF) type is adopted for the LIDAR sensor. Specifically, the plurality of light emitting units of the LIDAR sensor have a function of radially emitting laser light while rotating in the horizontal direction during a light emitting time period set in advance. The light receiving unit of the LIDAR sensor has a function of receiving reflected light from an object during a light receiving time period set in advance. The calculation unit of the LIDAR sensor has a function of obtaining round-trip times each being a difference between a light emitting time in the plurality of light emitting units and a light receiving time in the light reception unit. The calculation unit of the LIDAR sensor has a function of obtaining the distances to the object based on the round-trip times.

The LIDAR sensor has a function of measuring also the direction to the object by obtaining the distance to the object. Thus, the position P of the detection point DP, the speed V of the detection point DP, and the direction θ of the object are observed from measurement results measured by the LIDAR sensor.

As described above, with the LIDAR sensor, the detection data DD including the speed V of the detection point DP and the direction θ of the object in addition to the position P of the detection point DP can be observed as the information on the object. Of the position P of the detection point DP, the speed V of the detection point DP, and the direction θ of the object, each of the speed V of the detection point DP and the direction θ of the object is the object identification element as described above.

Moreover, the speed resolution of the LIDAR sensor is determined by a light emission interval of pulses forming the laser light. Thus, as the light emission interval of the pulses forming the laser light decreases, the speed resolution of the LIDAR sensor increases.

For example, in the case in which the own vehicle is traveling on an expressway, compared with the case in which the own vehicle is traveling on a general road, the speed resolution of the LIDAR sensor can be set to be higher by setting the light emission interval of the pulses forming the laser light irradiated from the LIDAR sensor to be short. Thus, in the case in which the own vehicle is traveling on an expressway, a change in the speed can be observed earlier compared with the case in which the own vehicle is traveling on a general road. Consequently, objects around the own vehicle can be observed earlier.

Moreover, the distance resolution of the LIDAR sensor is determined by a pulse width forming the laser light. Thus, as the pulse width forming the laser light decreases, the distance resolution of the LIDAR sensor increases.

For example, in the case in which the own vehicle is traveling in a parking lot, compared with the case in which the own vehicle is traveling on a general road or an expressway, the pulse width forming the laser light irradiated from the LIDAR sensor is set to be shorter. Consequently, the distance resolution of the LIDAR sensor can be set to be high. In a case in which the distance resolution of the LIDAR sensor is set to be high, the detectable minimum unit distance around the own vehicle is short, and thus it is possible to distinguish objects existing side by side from each other.

For example, when a pedestrian and the vehicle C exist as the objects around the own vehicle, there is brought about a state in which there simultaneously exist the pedestrian having low reflection intensity to the laser light irradiated from the LIDAR sensor and the vehicle C having high reflection intensity thereto. Even under this state, the reflection light reflected from the pedestrian is not absorbed by the reflection light reflected from the vehicle C, and the pedestrian can thus be detected.

The camera is mounted next to the inner rear view mirror on the cabin side of the windshield. As the camera, for example, a monocular camera is used. The monocular camera includes an image pickup element. The image pickup element is, for example, a charge coupled device (CCD) image sensor or a complementary metal oxide semiconductor (CMOS) image sensor. The monocular camera continuously detects absence or presence of an object and a distance thereto while the minimum unit is a pixel level in a 2D space orthogonal to an image pickup direction of the image pickup element. The monocular camera includes, for example, structure in which a filter of primary colors including red, green, and blue is added to a lens. With this structure, the distance can be obtained based on parallax among light rays divided by the filter of the primary colors. Thus, the position P of the detection point DP and a width W and a length L of the object are observed from measurement results measured by the camera.

As described above, with the camera, the detection data DD including the width W and the length L of the object in addition to the position P of the detection point DP can be observed as the information on the object. Of the position P of the detection point DP, and the width W and the length L of the object, the width W and the length L of the object are static elements for identifying the size of the object. Each of those static elements is an object identification element.

For the camera, in addition to the monocular camera, a TOF camera, a stereo camera, an infrared camera, or the like is used.

The plurality of vehicle information sensors 2 have functions of detecting, as own vehicle data cd, vehicle information on the own vehicle such as a vehicle speed, a steering angle, and a yaw rate. The own vehicle data cd is generated to have a data configuration that can be supplied to the object recognition device 3.

The object recognition device 3 includes a time measurement unit 31, a data reception unit 32, a temporary setting unit 33, a prediction processing unit 34, a association processing unit 35, and an update processing unit 36. The time measurement unit 31, the data reception unit 32, the temporary setting unit 33, the prediction processing unit 34, the association processing unit 35, and the update processing unit 36 have functions achieved by a CPU which executes programs stored in a nonvolatile memory or a volatile memory.

The time measurement unit 31 has a function of measuring a time of the object recognition device 3. The time measuring unit 31 generates a measured time as a common time CT. The common time CT is generated to have a data configuration that can be supplied to the data reception unit 32.

The data reception unit 32 has a function of an input interface.

Specifically, the data reception unit 32 has a function of receiving the detection data dd from each external information sensor 1. Pieces of detection data dd are integrated into the detection data DD by the data reception unit 32. The data reception unit 32 has a function of associating the common time CT generated by the time measurement unit 31 with the detection data DD as an associated time RT, to thereby generate detection data DD_{RT}. The detection data DD_{RT} is generated to have a data configuration that can be supplied to each of the temporary setting unit 33 and the association processing unit 35.

When the data reception unit 32 receives the detection data dd from the external information sensor 1, the data reception unit 32 determines that the detection data dd has successfully been acquired. The data reception unit 32 sets, to 0, a defect flag indicating that a defect is occurring in the corresponding external information sensor 1, and generates the detection data DD_{RT}.

When the defect flag is set to 0, this setting indicates that a defect is not occurring in the corresponding external information sensor 1. Moreover, when the defect flag is set to 1, this setting indicates that a defect is occurring in the corresponding external information sensor 1.

Meanwhile, when the data reception unit 32 does not receive the detection data dd from the external information sensor 1, the data reception unit 32 determines that the detection data dd cannot be received, sets the defect flag to 1, and does not generate the detection data DD_{RT}.

Moreover, when the data reception unit 32 receives the detection data dd from the external information sensor 1, the data reception unit 32 determines validity of the detection data dd. When the data reception unit 32 determines that the detection data dd is not valid, the data reception unit 32 determines that the detection data dd cannot be acquired, and sets a data validity flag to 0, which indicates that the detection data dd of the corresponding external information sensor 1 is not valid. When the data reception unit 32 determines that the detection data dd is valid, the data reception unit 32 determines that the detection data dd has successfully been acquired, and sets the data validity flag to 1.

As described above, the result of determining, by the data reception unit 32, whether or not the detection data dd has successfully been acquired can be referred to by referring to at least one of the defect flag or the data validity flag.

Moreover, the data reception unit 32 has a function of receiving the own vehicle data cd from the vehicle information sensors 2. The data reception unit 32 has a function of associating the common time CT generated by the time measurement unit 31 with the own vehicle data cd as the associated time RT, to thereby generate own vehicle data CD_{RT}. The own vehicle data CD_{RT} is generated to have a data configuration that can be supplied to the prediction processing unit 34.

The temporary setting unit 33 has a function of setting a position HP of at least one candidate point DPH on an object model C_{model1} obtained by modeling a tracking target based on the resolution of the external information sensors 1 that has detected, as the tracking target, at least one object of a plurality of objects. The temporary setting unit 33 has a function of generating temporary set data DH including the position HP of the at least one candidate point DPH. The temporary set data DH is generated by the temporary setting unit 33 to have a data configuration that can be supplied to the association processing unit 35.

The resolution of the external information sensor 1 is included in specifications of the external information sensor 1. Moreover, the resolution of the external information sensor 1 changes depending on specifications of the external information sensor 1. Attributes relating to operation settings of the external information sensor 1, attributes relating to an arrangement situation of the external information sensor 1, and the like are identified based on the specifications of the external information sensor 1. The attributes relating to the operation settings of the external information sensor 1 are an observable measurement range, resolution in the measurement range, a sampling frequency, and the like. The attributes relating to the arrangement situation of the external information sensor 1 are angles at which the external information sensor 1 can be arranged, an ambient temperature at which the external information sensor 1 can withstand, a measurable distance between the external information sensor 1 and an observation target, and the like.

The prediction processing unit 34 has a function of receiving the own vehicle data CD_{RT} from the data reception unit 32. The prediction processing unit 34 has a function of receiving track data TD_{RT-1} from the update processing unit 36. A previous associated time RT corresponding to a previous time of the current associated time RT, that is, an associated time RT-1, is associated with the track data TD_{RT-1} of the track data TD. The prediction processing unit 34 has a function of generating prediction data TD_{RTprod} of the track data TD_{RT} at the associated time RT, by a well-known algorithm, based on the own vehicle data CD_{RT} at the associated time RT and the track data TD_{RT-1} at the associated time RT-1. The well-known algorithm is the Kalman filter or another algorithm that can predict, from observed values, a center point in an object that changes in a time series.

That is, the prediction processing unit 34 predicts, as a prediction position PredP on the object model C_{model1} obtained by modeling the tracking target, a position of a movement destination of the tracking target based on a trajectory formed by movement of at least one object of a plurality of objects as the tracking target. The prediction position PredP is included in the prediction data TD_{RTpred}. The prediction position PredP is a position of a prediction point Pred. The prediction point Pred is set around the object model C_{model1} as a center. Thus, the prediction position PredP is set to the center of the object model C_{model1}.

The association processing unit 35 has a function of receiving the detection data DD_{RT}, the temporary set data DH including the positions HP of the candidate points DPH, and the predicted data TD_{RTpred} of the track data TD_{RT}. The association processing unit 35 has a function of determining whether or not the detection data DD_{RT} and the prediction data TD_{RTpred} of the track data TD_{RT} associate with each other. Whether or not the detection data DD_{RT} and the prediction data TD_{RTpred} of the track data TD_{RT} associate with each other is determined through use of a simple nearest neighbor (SNN) algorithm, a global nearest neighbor (GNN) algorithm, a joint probabilistic data association (JPDA) algorithm, or the like.

That is, the association processing unit 35 identifies a reference position BP on the object model C_{model1} based on the position HP of the candidate point DPH and the prediction position PredP. The association processing unit 35 sets a association range RA having the reference position BP on the object model C_{model1} as a reference. The association processing unit 35 determines whether or not the position P of the detection point DP and the prediction position PredP associate with each other based on a positional relationship between the association range RA and the detection point DP at the time when the external information sensor 1 has detected at least one object of a plurality of objects.

Specifically, whether or not the detection data DD_{RT} and the prediction data TD_{RTpred} of the track data TD_{RT} associate with each other is determined based on whether or not a Mahalanobis distance dm exceeds the association range RA. The Mahalanobis distance dm is derived based on the position P of the detection point DP included in the detection data DD_{RT} and the prediction position PredP included in the prediction data TD_{RTpred} of the track data TD_{RT}. When the derived Mahalanobis distance dm does not exceed the association range RA, it is determined that the detection data DD_{RT} and the prediction data TD_{RTpred} of the track data TD_{RT} associate with each other. When the derived Mahalanobis distance dm exceeds the association range RA, it is determined that the detection data DD_{RT} and the prediction data TD_{RTpred} of the track data TD_{RT} do not associate with each other.

That is, the association processing unit 35 determines whether or not the position P of the detection point DP and the prediction position PredP associate with each other.

In the above-mentioned example, as the index for the comparison with the association range RA, the Mahalanobis distance dm derived based on the position P of the detection point DP and the prediction position PredP are used, but the configuration is not limited to this example.

As described above, the association range RA is set so that the association range PA has the reference position BP as the reference. The reference position BP is identified based on the position HP of the candidate point DPH and the prediction position PredP. Thus, the prediction position PredP and the reference position BP associate with each other. Consequently, the Mahalanobis distance dm may be derived based on the position P of the detection point DP and the reference position BP.

Moreover, the index for the comparison with the association range PA may not be the Mahalanobis distance dm. A Euclidean distance du of a difference vector between the position P of the detection point DP and the reference position BP may be used. In this case, whether or not the detection data DD_{RT} and the prediction data TD_{RTpred} of the track data TD_{RT} associate with each other may be determined based on whether or not the Euclidean distance du exceeds the association range RA.

That is, the association processing unit 35 determines whether or not the position P of the detection point DP and the prediction position PredP associate with each other based on whether or not one of the Euclidean distance du of the difference vector between the position P of the detection point DP and the reference position BP or the Mahalanobis distance dm derived based on the position P of the detection point DP and the reference position BP exceeds the association range RA.

The association range RA is set to an observable range of the external information sensor 1. The observable range of the external information sensor 1 changes depending on the type of the external information sensor 1. Thus, the association range RA changes depending on the type of the external information sensor 1.

The association processing unit 35 has a function of determining that the detection data DD_{RT} and the prediction data TD_{RTpred} of the track data TD_{RT} correspond to each other when the detection data DD_{RT} and the prediction data TD_{RTpred} of the track data TD_{RT} associate with each other. The association processing unit 35 has a function of generating association data RD_{RT} obtained by integrating, together with the data relating to the determined correspondence, the detection data DD_{RT}, the temporary set data DH including the positions HP of the candidate points DPH, and the prediction data TD_{RTpred} of the track data TD_{RT}. The association data RD_{RT} is generated by the association processing unit 35 to have a data configuration that can be supplied to the update processing unit 36.

The update processing unit 36 has a function of receiving the association data RD_{RT}. The update processing unit 36 has a function of updating the track data TD_{RT} based on the position P of the detection point DP and the positions HP of the candidate points DPH. The track data TD_{RT} is updated by, specifically, tracking processing such as a least-squares method, a Kalman filter, and a particle filter.

The notification control device 4 has a function of receiving the track data TD_{RT}. The notification control device 4 has a function of generating notification data based on the track data TD_{RT}. The notification data is data for identifying contents to be notified, and is generated to have a format that corresponds to a device being an output destination. The notification control device 4 outputs the notification data to a display (not shown), to thereby cause the display to notify the contents of the notification data. Consequently, the contents of the notification data are visually notified to a driver in the cabin. The notification control device 4 outputs the notification data to a speaker (not shown), to thereby cause the speaker to notify the contents of the notification data. Consequently, the contents of the notification data are aurally notified to the driver in the cabin.

The vehicle control device 5 has a function of receiving the track data TD_{RT} output by the update processing unit 36. The vehicle control device 5 has a function of controlling operation of the own vehicle based on the track data TD_{RT}. The vehicle control device 5 controls the operation of the own vehicle based on the track data TD_{RT} so that the own vehicle avoids objects.

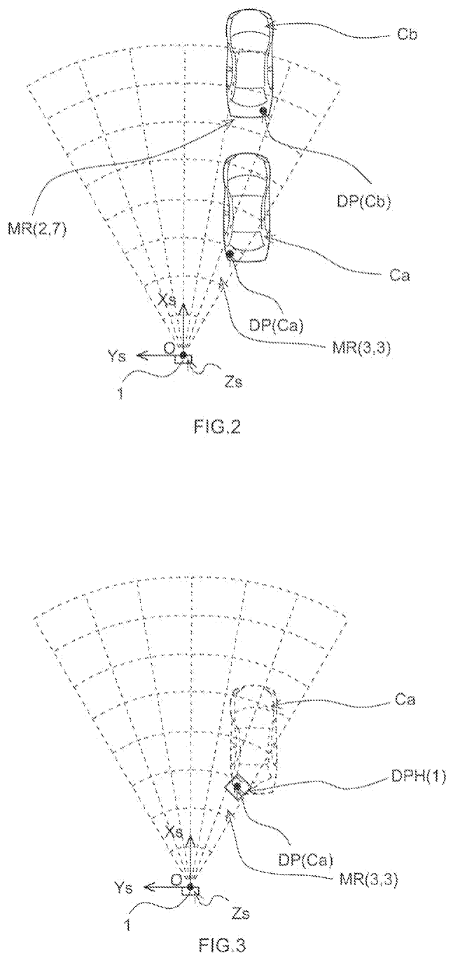

FIG. 2 is a diagram for illustrating an example of relative positional relationships between the sensor of FIG. 1 and objects.

A point at the center of the external information sensor 1 as viewed from the front side is set as an origin O. A horizontal axis that passes through the origin O and is in the left-and-right direction is defined as Ys axis. On the Ys axis, a right direction as the external information sensor 1 is viewed from the front side is defined as a positive direction. A vertical axis that passes through the origin O and is in the up-and-down direction is defined as Zs axis. On the Zs axis, an up direction as the external information sensor 1 is viewed from the front side is defined as a positive direction. An axis that passes through the origin O and is in a front-and-rear direction orthogonal to the Ys axis and the Zs axis is defined as an Xs axis. On the Xs axis, a front direction of the external information sensor 1 is defined as a positive direction.

As indicated by the broken lines of FIG. 2, an observable range of the external information sensor 1 is divided into a plurality of virtual resolution cells. The resolution cells are identified based on the resolution of the external information sensor 1. The resolution cells are obtained by dividing the observable range of the external information sensor 1 in accordance with angle resolution and the distance resolution of the external information sensor 1. As described above, the angle resolution and the distance resolution of the external information sensor 1 vary depending on the measurement principle of the external information sensor 1.

Each resolution cell is identified by a minimum detection range MR(i, j). The value “i” identifies a location of the resolution cell along a circumferential direction with respect to the origin O as a reference. The value “j” identifies a location of the resolution cell along a radial direction of concentric circles with respect to the origin O as a reference. Thus, the number of “i's” varies depending on the angle resolution of the external information sensor 1. Consequently, as the angle resolution of the external information sensor 1 increases, the maximum number of “i's” increases. Meanwhile, the number of “j's” varies depending on the distance resolution of the external information sensor 1. Thus, as the distance resolution of the external information sensor 1 increases, the maximum number of “j's” increases. Regarding a positive sign and a negative sign of “i”, a clockwise direction with respect to the Xs axis as a reference is defined as a positive circumferential direction. A counterclockwise direction with respect to the Xs axis as the reference is defined as a negative circumferential direction.

When the external information sensor 1 detects a vehicle Ca, a detection point DP(Ca) is included in a minimum detection range MR(3, 3). The minimum detection range MR(3, 3) is set to such a size that only a rear left side of the vehicle Ca is included. Thus, a positional relationship between the position P of the detection point DP(Ca) and the vehicle Ca is identified, and hence the position P of the detection point DP(Ca) on the vehicle Ca is identified as the rear left side of the vehicle Ca. Moreover, the detection point DP(Ca) is included in the minimum detection range MR(3, 3), and hence the position P of the detection point DP(Ca) with respect to the external information sensor 1 is identified as a position P of the closest point having the shortest distance from the external information sensor 1 to the vehicle Ca.

Meanwhile, when the external information sensor 1 detects a vehicle Cb, a detection point DP(Cb) is included in a minimum detection range MR(2, 7). When those minimum detection ranges are compared with each other along the radial direction of the concentric circles with respect to the origin O as the reference, the minimum detection range MR(2, 7) is more apart from the origin O than the minimum detection range MR(3, 3). As the minimum detection range MR(i, j), that is, the resolution cell, becomes more apart from the origin O along the radial direction of the concentric circles, the angle resolution of the external information sensor 1 decreases. Thus, the angle resolution of the external information sensor 1 in the minimum detection range MR(2, 7) is lower than the angle resolution of the external information sensor 1 in the minimum detection range MR(3, 3).

Moreover, the minimum detection range MR(2, 7) is set to such a size that an entire rear portion of the vehicle Cb is included. Thus, it is not possible to determine which position P of the entire rear portion of the vehicle Cb the position P of the detection point DP(Cb) is. Thus, it is not possible to identify a positional relationship between the position P of the detection point DP(Cb) and the vehicle Cb. Consequently, the position P of the detection point DP(Cb) on the vehicle Cb cannot be identified.

Description is now given of processing of identifying the position P of the detection point DP(Ca) on the vehicle Ca and the position P of the detection point DP(Cb) on the vehicle Cb.

FIG. 3 is a diagram for illustrating an example of a candidate point DPH(1) being a first candidate of a position P of a detection point DP(Ca) on the vehicle Ca of FIG. 2. When the external information sensor 1 detects the vehicle Ca as an object, the detection point DP(Ca) is included in the minimum detection range MR(3, 3). The minimum detection range MR(3, 3) is set to such a size that only the rear left side of the vehicle Ca is included. Thus, as described above, as the position P of the detection point DP(Ca) on the vehicle Ca, the closest point is estimated. When the closest point is estimated as the position P of the detection point DP(Ca) on the vehicle Ca, the position HP of the candidate point DPH(1) is a first candidate of the position P of the detection point DP(Ca) on the vehicle Ca.

In other words, in the example of FIG. 3, the position HP of the candidate point DPH(1) is the first candidate of the position P of the detection point DP(Ca) on the vehicle Ca.

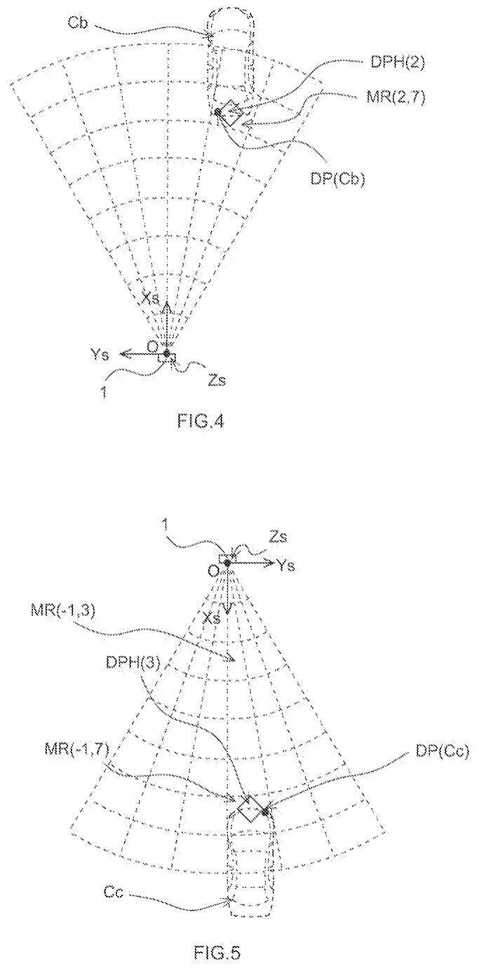

FIG. 4 is a diagram for illustrating an example of a candidate point DPH(2) being a second candidate of a position P of a detection point DP(Cb) on the vehicle Cb of FIG. 4. When the external information sensor 1 detects the vehicle Cb as an object, the detection point DP(Cb) is included in the minimum detection range MR(2, 7). The minimum detection range MR(2, 7) is set to such a size that the entire rear portion of the vehicle Cb is included. Thus, as described above, it is not possible to determine which position P of the entire rear portion of the vehicle Cb the position P of the detection point DP(Cb) is. When it is not possible to determine which position P of the entire rear portion of the vehicle Cb the position P of the detection point DP(Cb) is, a position HP of a candidate point DPH(2) is the second candidate of the position P of the detection point DP(Cb) on the vehicle Cb. The position HP of the candidate point DPH(2) is estimated as a rear-surface center point in the rear portion of the vehicle Cb. The rear-surface center point is a point at the center observed when the rear portion of the vehicle Cb is viewed from the front side.

In other words, in the example of FIG. 4, the position HP of the candidate point DPH(2) is the second candidate of the position P of the detection point DP(Cb) on the vehicle Cb.

FIG. 5 is a diagram for illustrating an example of a candidate point DPH(3) being another candidate of the position P of the detection point DP(Cc) on the vehicle Cc. When the external information sensor 1 detects the vehicle Cc as an object, the detection point DP(Cc) is included in the minimum detection range MR(−1, 7). For example, the minimum detection range MR(−1, 7) is more apart from the origin O than a minimum detection range MR(−1, 3). Thus, the angle resolution of the external information sensor 1 in the minimum detection range MR(−1, 7) is lower than the angle resolution of the external information sensor 1 in the minimum detection range MR(−1, 3).

Specifically, the minimum detection range MR(−1, 7) is set to such a size that an entire front portion of the vehicle Cc is included. Thus, it is not possible to determine which position P of the entire front portion of the vehicle Cc the position P of the detection point DP(Cc) is. When it is not possible to determine which position P of the entire front portion of the vehicle Cc the position P of the detection point DP(Cc) is, a position HP of a candidate point DPH(3) is another candidate of the position P of the detection point DP(Cc) on the vehicle Cc. The position HP of the candidate point DPH(3) is estimated as a front-surface center point in the front portion of the vehicle Cc. The front-surface center point is a point at the center observed when the front portion of the vehicle Cc is viewed from the front side.

In other words, in the example of FIG. 5, the position HP of the candidate point DPH(3) is another candidate of the position P of the detection point DP(Cc) on the vehicle Cc.

Referring to FIG. 3 and FIG. 4, when the external information sensor 1 is a millimeter wave radar for monitoring the front side of the own vehicle, the position HP of the candidate point DPH(1) is the candidate of the position P of the detection point DP(Ca) on the vehicle Ca. Moreover, the position HP of the candidate point DPH(2) is a candidate of the position P of the detection point DP(Cb) on the vehicle Cb.

Moreover, referring to FIG. 4, when the external information sensor 1 is a camera for monitoring the front side of the own vehicle, the position HP of the candidate point DPH(2) is the candidate of the position P of the detection point DP(Cb) on the vehicle Cb.

Referring to FIG. 3 and FIG. 5, when the external information sensor 1 is a millimeter wave radar for monitoring the rear side of the own vehicle, the position HP of the candidate point DPH(1) is the candidate of the position P of the detection point DP(Ca) on the vehicle Ca. Moreover, the position HP of the candidate point DPH(3) is a candidate of the position P of the detection point DP(Cc) on the vehicle Cc.

As described above, when there are a plurality of candidate points DPH of the position P of the detection point DP, it is not possible to identify the respective positions P of the detection point DP(Ca) on the vehicle Ca, the detection point DP(Cb) on the vehicle Cb, and the detection point DP(Cc) on the vehicle Cc.

Description is now given of processing of adopting one candidate point DPH of a plurality of candidate points DPH(N). In the following description, when the vehicle Ca, the vehicle Cb, and the vehicle Cc are collectively referred to, those vehicles are referred to as “vehicle C.” Further, when the detection point DP(Ca), the detection point DP(Cb), and the detection point DP(Cc) are collectively referred to, those detection points are referred to as “detection point DP(C).”

FIG. 6 is a graph for showing a setting example of a reliability DOR(N) of the candidate point DPH(N) of FIG. 3 to FIG. 5 where N is a natural number. In the example of FIG. 6, to the reliability DOR(N), a real number of 0 or more and 1 or less is set. As described above, when the external information sensor 1 is a millimeter wave radar for monitoring the front side of the own vehicle, the candidate point DPH(1) and the candidate point DPH(2) are the candidates of the detection point DP(C) on the vehicle C.

Thus, a reliability DOR(1) for the candidate point DPH(1) and a reliability DOR(2) for the candidate point DPH(2) are compared to each other, and one of the candidate point DPH(1) or the candidate point DPH(2) is consequently selected, and is set as the candidate of the position P of the detection point DP(C) on the vehicle C. Consequently, one of the candidate point DPH(1) or the candidate point DPH(2) is adopted.

Specifically, as described above, as the resolution cell becomes more apart from the origin O along the radial direction of the concentric circles, the angle resolution of the external information sensor 1 decreases. In other words, as the resolution cell becomes closer to the origin O along the radial direction of the concentric circles, the angle resolution of the external information sensor 1 increases.

Thus, when the distance from the external information sensor 1 to the detection point DP(C) is short, the rear portion of the vehicle C is not buried in the resolution cell. Accordingly, when the distance from the external information sensor 1 to the detection point DP(C) is short, the reliability DOR is high.

In other words, the reliability DOR of the candidate point DPH is determined based on the distance from the external information sensor 1 to the position P of the detection point DP. Moreover, the reliability DOR of the candidate point DPH is determined based on the distance from the external information sensor 1 to the reference position BP. That is, the association processing unit 35 obtains each reliability DOR based on the distance from the external information sensor 1 to at least one of the position P of the detection point DP or the reference position BP.

Thus, when the distance from the external information sensor 1 to the detection point DP(C) is shorter than a determination threshold distance D_{TH1} of FIG. 6, the reliability DOR(1) for the candidate point DPH(1) is set to 1, and the reliability DOR(2) for the candidate point DPH(2) is set to 0. In this case, the reliability DOR(1) is higher in reliability DOR than the reliability DOR(2), and the reliability DOR(1) is thus selected. When the reliability DOR(1) is selected and set, the candidate point DPH(1) corresponding to the reliability DOR(1) is adopted. The position HP of the candidate point DPH(1) on the vehicle C is the position P of the closest point on the vehicle C.

Thus, the position P of the detection point DP(C) on the vehicle C is assumed to be the position P of the closest point on the vehicle C based on the position HP of the adopted candidate point DPH(1).

In other words, when the distance from the external information sensor 1 to the detection point DP(C) is shorter than the determination threshold distance D_{TH1} of FIG. 6, the position HP of the candidate point DPH(1) of the plurality of candidate points DPH(N) is selected as the candidate of the position P of the detection point DP(C) on the vehicle C. Consequently, the position P of the detection point DP(C) on the vehicle C is assumed to be the position P of the closest point on the vehicle C.

Meanwhile, when the distance from the external information sensor 1 to the detection point DP(C) is long, the rear portion of the vehicle C is buried in the resolution cell. Thus, when the distance from the external information sensor 1 to the detection point DP(C) is long, the reliability DOR is low.

Thus, when the distance from the external information sensor 1 to the detection point DP(C) is equal to or longer than a determination threshold distance D_{TH2} of FIG. 6, the reliability DOR(1) for the candidate point DPH(1) is set to 0, and the reliability DOR(2) for the candidate point DPH(2) is set to 1. In this case, the reliability DOR(2) is higher in reliability DOR than the reliability DOR(1), and the reliability DOR(2) is thus selected. When the reliability DOR(2) is selected and set, the candidate point DPH(2) corresponding to the reliability DOR(2) is adopted. The position HP of the candidate point DPH(2) on the vehicle C is the position P of the rear-surface center point on the vehicle C.

Thus, the position P of the detection point DP(C) on the vehicle C is assumed to be the position P of the rear-surface center point on the vehicle C based on the position HP of the adopted candidate point DPH(2).

In other words, when the distance from the external information sensor 1 to the detection point DP(C) is equal to or longer than the determination threshold distance D_{TH2} of FIG. 6, the position HP of the candidate point DPH(2) of the plurality of candidate points DPH(N) is selected as the candidate of the position P of the detection point DP(C) on the vehicle C. Consequently, the position P of the detection point DP(C) on the vehicle C is assumed to be the position P of the rear-surface center point on the vehicle C.

As described above, the association processing unit 35 adopts a candidate point DPH(N) having the highest reliability DOR(N) of the positions HP of the plurality of candidate points DPH(N) on the vehicle C.

The determination threshold distance D_{TH1} of FIG. 6 is set to a distance including the minimum detection range MR(3, 3) of FIG. 3 or FIG. 5 of the distance from the origin O along the radial direction of the concentric circles. That is, the determination threshold distance D_{TH1} of FIG. 6 is set to a distance including the minimum detection range MR(i, 3) of FIG. 3, FIG. 4, and FIG. 5 of the distance from the origin O along the radial direction of the concentric circles.

Meanwhile, the determination threshold distance D_{TH2} of FIG. 6 is set to, of the distance from the origin O along the radial direction of the concentric circles, a distance including the minimum detection range MR(2, 7) of FIG. 4. That is, the determination threshold distance D_{TH2} of FIG. 6 is set to, of the distance from the origin O along the radial direction of the concentric circles, a distance including the minimum detection range MR(i, 7) of FIG. 3, FIG. 4, and FIG. 5.

In other words, the threshold distance D_{TH2} is set to a distance more apart from the origin O than the determination threshold distance D_{TH1}.

Specifically, the reliability DOR(1) is set to 1 when the distance is shorter than the determination threshold distance D_{TH1}. The reliability DOR(1) starts decreasing as the distance becomes equal to or longer than the determination threshold distance D_{TH1}. The reliability DOR(1) is set to 0 when the distance is equal to or longer than the determination threshold distance D_{TH2}.

Meanwhile, the reliability DOR(2) is set to 0 when the distance is shorter than the determination threshold distance D_{TH1}. The reliability DOR(2) starts increasing as the distance becomes equal to or longer than the determination threshold distance D_{TH1}. The reliability DOR(2) is set to 1 when the distance is equal to or longer than the determination threshold distance D_{TH2}.

As described above, the reliability DOR(1) and the reliability DOR(2) are set so that tendencies opposite to each other are indicated when the distance is shorter than the determination threshold distance D_{TH1} and when the distance is equal to or longer than the determination threshold distance D_{TH2}.

Each of the reliability DOR(1) and the reliability DOR(2) at the time when the distance is equal to or longer than the determination threshold distance D_{TH1} and is shorter than the determination threshold distance D_{TH2} is determined based on a ratio between the distance resolution and the angle resolution of the external information sensor 1.

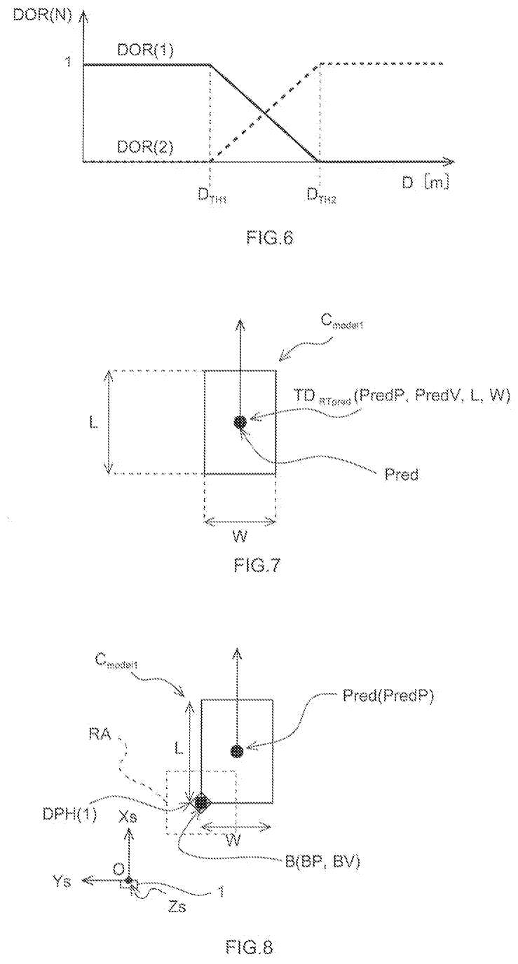

FIG. 7 is a diagram for illustrating an example of the prediction data TD_{RTpred} of FIG. 1.

The prediction data TD_{RTpred} includes four pieces of data, namely, the prediction position PredP of the prediction point Pred in the object model C_{model1} obtained by modeling, as the tracking target, the vehicle C being an object, a speed PredV of the prediction point Pred, and a width W and a length L of the object model C_{model1}.

Of the four pieces of data of the prediction position PredP of the prediction point Pred in the object model C_{model1}, the speed PredV of the prediction point Pred, and the width W and the length L of the object model C_{model1}, three pieces of data of the speed PredV of the prediction point Pred and the width W and the length L of the object model C_{model1} are object identification elements.

The object identification element identifies at least one of the state or the size of the object model C_{model1}.

The prediction point Pred in the object model C_{model1} is set to a center point of the object model C_{model1}. Thus, the prediction position PredP of the prediction point Pred is at the center of the object model C_{model1}.

The prediction position PredP of the prediction point Pred in the object model C_{model1} and the speed Pred V of the prediction point Pred indicate states of the object observable by a millimeter wave radar or a LIDAR sensor. The width W and the length L of the object model C_{model1} indicate the size of the object observable by a camera.

Thus, the prediction data TD_{RFpred} is data formed by integrating the observation results of the plurality of different types of external information sensors 1. For example, the prediction data TD_{RTpred} is configured as vector data such as TD_{RTpred} (PredP, PredV, L, W).

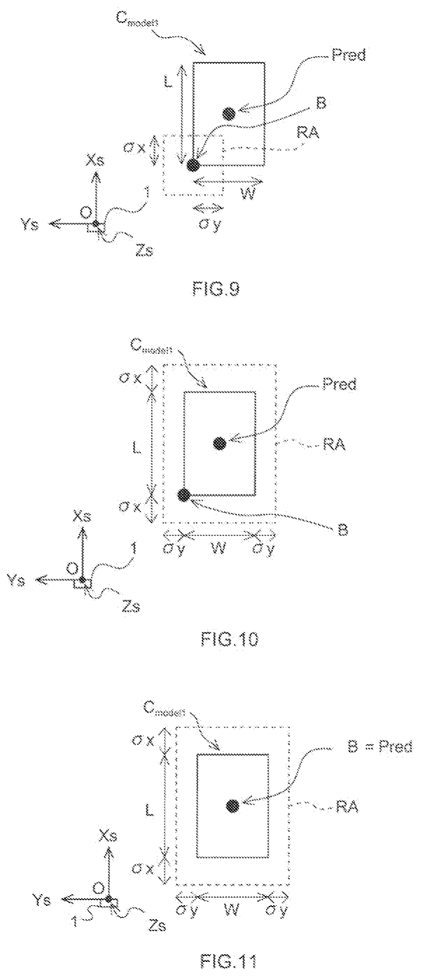

FIG. 8 is a diagram for illustrating an example of the reference position BP identified based on the prediction position PredP of the prediction data TD_{RTpred} of FIG. 7 and the candidate point DPH(1).

As described above, the prediction position PredP is the position of the prediction point Pred. The prediction point Pred is set to the center point in the object model C_{model1}. Moreover, the position HP of the candidate point DPH(1) is the position of the closest point on the object model C_{model1}.

Moreover, as described above, the prediction data TD_{RTpred} includes four pieces of data of the prediction position PredP of the prediction point Pred in the object model C_{model1}, the speed PredV of the prediction point Pred, and the width W and the length L of the object model C_{model1}.

When the candidate point DPH(1) is adopted as the candidate point DPH(N) having the highest reliability DOR(N), the closest point on the object model C_{model1} is adopted as the candidate point DPH. The position of the closest point is identified as the reference position BP of the reference point B.

Thus, to the reference position BP on the object model C_{model1} in the Ys axis direction, a position obtained by adding ½ of the width W to the prediction position PredP is set. Moreover, to the reference position BP on the object model C_{model1} in the Xs axis direction, a position obtained by subtracting ½ of the length L from the prediction position PredP is set.

That is, the association processing unit 35 identifies the reference position BP on the object model C_{model1} based on an object identification element that identifies at least one of the state or the size of the object model C_{model1}.

Specifically, when the association processing unit 35 has successfully acquired, as an object identification element from the external information sensor 1, at least one of the width W or the length L of the object model C_{model1}, the association processing unit 35 has successfully acquired the object identification element in addition to the prediction position PredP and the candidate point DPH.

In this case, the association processing unit 35 identifies the reference position BP of the association range RA at the current associated time RT based on the prediction position PredP, the candidate point DPH, and the acquired object identification element.

When the association processing unit 35 has not successfully acquired, as an object identification element from the external information sensor 1, at least one of the width W or the length L of the object model C_{model1}, the association processing unit 35 has successfully acquired the prediction position PredP and the candidate point DPH, but has not successfully acquired the object identification element.

In this case, the association processing unit 35 identifies a set value that corresponds to the object identification element that cannot be acquired from the external information sensor 1, among the set values set in advance individually in correspondence with the width W and the length L of the object model C_{model1}.

The association processing unit 35 identifies the value of the object identification element that cannot be acquired from the external information sensor 1 based on the identified set value. That is, the association processing unit 35 identifies the reference position BP of the association range RA at the current associated time RT based on the prediction position PredP, the candidate point DPH, and the set value.

There is also a case in which the association processing unit 35 cannot acquire, as an object identification element, at least one of the width W or the length L of the object model C_{model1} from the external information sensor 1, and the respective set values are not individually set in correspondence with the width W and the length L of the object model C_{model1}.

In this case, the association processing unit 35 identifies the reference position BP of the association range RA at the current associated time RT based on the prediction position PredP and the candidate point DPH. Specifically, the association processing unit 35 identifies the reference position BP of the association range PA at the current associated time RT based on the difference vector between the prediction position PredP and the candidate point DPH.

Description is now given of a case in which at least one of the width W, the length L, or the direction θ of the object model C_{model1} is included in object identification elements.

Moreover, when the association processing unit 35 has successfully acquire, as an object identification element from the external information sensor 1, at least one of the width W, the length L, or the direction θ of the object model C_{model1}, the association processing unit 35 identifies the reference position BP of the association range RA at the current associated time RT based on the prediction position PredP, the candidate point DPH, and the acquired object identification element.

When the association processing unit 35 has not successfully acquired, as an object identification element from the external information sensor 1, at least one of the width W, the length L, or the direction θ of the object model C_{model1}, the association processing unit 35 has successfully acquired the prediction position PredP and the candidate point DPH, but has not successfully acquired the object identification element.

In this case, the association processing unit 35 identifies a set value that corresponds to the object identification element that cannot be acquired from the external information sensor 1, among the set values set in advance individually in correspondence with the width W, the length L, or the direction θ of the object model C_{model1}.

The association processing unit 35 identifies the value of the object identification element that cannot be acquired from the external information sensor 1 based on the identified set value. That is, the association processing unit 35 identifies the reference position BP of the association range RA at the current associated time RT based on the prediction position PredP, the candidate point DPH, and the set value.

There is also a case in which the association processing unit 35 cannot acquire, as an object identification element, at least one of the width W, the length L, or the direction θ of the object model C_{model1} from the external information sensor 1, and the respective set values are not individually set in correspondence with the width W, the length L, and the direction θ of the object model C_{model1}.

In this case, the association processing unit 35 identifies the reference position BP of the association range RA at the current associated time RT based on the prediction position PredP and the candidate point DPH. Specifically, the association processing unit 35 identifies the reference position BP of the association range RA at the current associated time RT based on the difference vector between the prediction position PredP and the candidate point DPH.

Description is now given of a case in which at least one of the width W, the length L, the direction θ, or the height H of the object model C_{model1} is included in object identification elements.

When the association processing unit 35 has not successfully acquired, as an object identification element from the external information sensor 1, at least one of the width W, the length L, the direction θ, or the height H of the object model C_{model1}, the association processing unit 35 has successfully acquired the prediction position PredP and the candidate point DPH, but has not successfully acquired the object identification element.

In this case, the association processing unit 35 identifies a set value that corresponds to the object identification element that cannot be acquired from the external information sensor 1, among the set values set in advance individually in correspondence with the width W, the length L, the direction θ, and the height H of the object model C_{model1}.

The association processing unit 35 identifies the value of the object identification element that cannot be acquired from the external information sensor 1 based on the identified set value. That is, the association processing unit 35 identifies the reference position BP of the association range RA at the current associated time RT based on the prediction position PredP, the candidate point DPH, and the set value.

There is also a case in which the association processing unit 35 cannot acquire, as an object identification element, at least one of the width W, the length L, the direction θ, or the height H of the object model C_{model1} from the external information sensor 1, and the respective set values are not individually set in correspondence with the width W, the length L, the direction θ, and the height H of the object model C_{model1}.

In this case, the association processing unit 35 identifies the reference position BP of the association range RA at the current associated time RT based on the prediction position PredP and the candidate point DPH. Specifically, the association processing unit 35 identifies the reference position BP of the association range RA at the current associated time RT based on the difference vector between the prediction position PredP and the candidate point DPH.

Description is now given of a case in which at least one of the width W, the length L, the direction θ, a position of an upper end Z_{H}, or a position of a lower end Z_{L} of the object model C_{model1} is included in object identification elements.

When the association processing unit 35 has not successfully acquired, as an object identification element from the external information sensor 1, at least one of the width W, the length L, the direction θ, the position of the upper end Z_{H}, or the position of the lower end Z_{L} of the object model C_{model1}, the association processing unit 35 has successfully acquired the prediction position PredP and the candidate point DPH, but has not successfully acquired the object identification element.

In this case, the association processing unit 35 identifies a set value that corresponds to the object identification element that cannot be acquired from the external information sensor 1, among the set values set in advance individually in correspondence with the width W, the length L, the direction θ, the position of the upper end Z_{H}, and the position of the lower end Z_{L} of the object model C_{model1}.

The association processing unit 35 identifies the value of the object identification element that cannot be acquired from the external information sensor 1 based on the identified set value. That is, the association processing unit 35 identifies the reference position BP of the association range RA at the current associated time RT based on the prediction position PredP, the candidate point DPH, and the set value.

There is also a case in which the association processing unit 35 cannot acquire, as an object identification element, at least one of the width W, the length L, the direction θ, the position of the upper end Z_{H}, or the position of the lower end Z_{L} of the object model C_{model1} from the external information sensor 1, and the respective set values are not individually set in correspondence with the width W, the length L, the direction θ, the position of the upper end Z_{H}, and the position of the lower end Z_{L} of the object model C_{model1}.

In this case, the association processing unit 35 identifies the reference position BP of the association range RA at the current associated time RT based on the prediction position PredP and the candidate point DPH. Specifically, the association processing unit 35 identifies the reference position BP of the association range RA at the current associated time RT based on the difference vector between the prediction position PredP and the candidate point DPH.

Description has been given of the case in which the candidate point DPH(1) is adopted as the candidate point DPH(N) having the highest reliability DOR(N). However, there may be used, not the position HP of the candidate point DPH(N) having the highest reliability DOR(N), but a position HP of a candidate point DPH(N) which is calculated by weighted average by the reliability DOR(N) for each of the positions P of the plurality of candidate points DPH(N).

Specifically, the association processing unit 35 identifies the reference position BP on the object model C_{model1}, which is calculated by weighted average for each of the positions HP of the plurality of candidate points DPH on the object, in accordance with the respective reliabilities DOR.

In summary, when the number of the candidate points DPH(N) is two or more on the object model C_{model1}, the association processing unit 35 identifies the reference position BP based on the respective reliabilities DOR(N) of the plurality of candidate points DPH(N) and the respective positions HP of the plurality of candidate points DPH(N).

As described above, the association range RA is set so that the association range RA has the reference position BP as the reference.

For example, positions along the Xs axis direction are set to +1 (m) and −1 (m) with respect to the reference position BP, respectively.

Moreover, positions along the Ys axis direction are set to +1 (m) and −1 (m) with respect to the reference position BP, respectively.

Moreover, speeds along the Xs axis direction are set to +3 (km/h) and −3 (km/h) with respect to a reference speed BV at the reference point B existing at the reference position BP, respectively.

Moreover, speeds along the Ys axis direction are set to +3 (km/h) and −3 (km/h) with respect to the reference speed BV at the reference point B existing at the reference position BP, respectively.

A position along the Xs axis direction is hereinafter referred to as “Xs axis position.” A position along the Ys axis direction is hereinafter referred to as “Ys axis position.” A speed along the Xs axis direction is hereinafter referred to as “Xs axis speed.” A speed along the Ys axis direction is hereinafter referred to as “Ys axis speed.”

FIG. 9 is a diagram for illustrating a first setting example of the association range RA set so that the association range RA has the reference position BP of FIG. 8 as the reference.

The size of the association range RA changes in accordance with the adopted candidate point DPH. When the candidate point DPH(1) is adopted, the reference position BP is set to the position of the closest point. At the reference point B existing at the reference position BP, the Xs axis position is represented by pnx, the Ys axis position is represented by pny, the Xs axis speed is represented by vnx, and the Ys axis speed is represented by vny.

Moreover, standard deviations of detection errors of the external information sensor 1 statistically measured in advance are obtained. A standard deviation of a detection error of the Xs axis position is represented by σx, a standard deviation of a detection error of the Ys axis position is represented by σy, a standard deviation of a detection error of the Xs axis speed is represented by σvx, and a standard deviation of a detection error of the Ys axis speed is represented by σvy.

Then, as illustrated in FIG. 9, the association range RA is set as follows.

Xs axis position: interval (pnx−σx, pnx+σx)
Ys axis position: interval (pny−σy, pny+σy)
Xs axis speed: interval (vnx−σvx, vnx+σvx)
Ys axis speed: interval (vny−σvy, vny+σvy)

FIG. 10 is a diagram for illustrating a second setting example of the association range PA set so that the association range RA has the reference position BP of FIG. 8 as the reference.

The width W of the object model C_{model1} and the length L of the object model C_{model1} included in the prediction data TD_{RTpred} are used.

As illustrated in FIG. 10, the association range RA is set as follows.

Xs axis position: interval (pnx−σx, pnx+σx+L)
Ys axis position: interval (pny−σy, pny+σy+W)
Xs axis speed: interval (vnx−σvx, vnx+σvx)
Ys axis speed: interval (vny−σvy, vny+σvy)

FIG. 11 is a diagram for illustrating a third setting example of the association range RA set so that the association range RA has the reference position BP of FIG. 8 as the reference.

When the candidate point DPH(2) is adopted, the reference position BP is set to the prediction position PredP. That is, the reference point B is set to the prediction point Pred. At the reference point B existing at the reference position BP, the Xs axis position is represented by pcx, the Ys axis position is represented by pcy, the Xs axis speed is represented by vcx, and the Ys axis speed is represented by vcy.

It is assumed that the standard deviation of the detection errors of the external information sensor 1 statistically measured in advance are the same as those described above.

Then, as illustrated in FIG. 11, the association range RA is set as follows.

Xs axis position: interval (pcx−σx-L/2, pcx+σx+L/2)
Ys axis position: interval (pcy−σy-W/2, pcy+σy+W/2)
Xs axis speed: interval (vcx−σvx, vcx+σvx)
Ys axis speed: interval (vcy−σvy, vcy+σvy)

The standard deviation of the detection errors of the external information sensor 1 statistically measured in advance may be reflected to the width W and the length L of the object model C_{model1} included in the prediction data TD_{RTpred}.

Specifically, for the width W of the object model C_{model1} included in the prediction data TD_{RTpred}, the standard deviation of the detection error of the external information sensor 1 is represented by σ_{W}. For the length L of the object model C_{model1} included in the prediction data TD_{RTpred}, the standard deviation of the detection error of the external information sensor 1 is represented by σ_{L}.

Then, in the association range RA, the width W and the length L of the object model C_{model1} included in the prediction data TD_{RTpred} are set as follows.

Width W: interval (W-σw, W+σw)
Length L: interval (L-σ_{L}, L+σ_{L})

When the direction θ is included in the prediction data TD_{RTpred}, a direction in the association range RA may be set as follows.

Direction: difference from θ is equal to or less than 45 [deg]

Moreover, the size of the association range RA may be adjusted in accordance with the reliability DOR of the candidate point DPH.

Specifically, the standard deviation of the detection error of the external information sensor 1 is multiplied by (1−DOR) as a coefficient in accordance with the reliability DOR.

Then, the association range RA is set as follows.

Xs axis position: interval (pnx−(2−DOR)σx, pnx+(2−DOR)σx)
Ys axis position: interval (pny−(2−DOR)σy, pny+(2−DOR)σy)
Xs axis speed: interval (vnx−(2−DOR)σvx, vnx+(2−DOR)σvx)
Ys axis speed: interval (vny−(2−DOR)σvy, vny+(2−DOR)σvy)

Thus, as the reliability DOR decreases, it is possible to more reflect influence of the standard deviations of the detection errors of the external information sensor 1. Consequently, as the reliability DOR decreases, the size of the association range RA can be increased.

In other words, the association processing unit 35 sets the association range RA based on the size of the object model C_{model1} having the prediction position PredP as the center and the statistical amounts of the detection errors which relate to the size of the object model C_{model1}, and are caused by the external information sensor 1.

Moreover, the association processing unit 35 adjusts the set size of the association range RA in accordance with the plurality of reliabilities DOR(N).

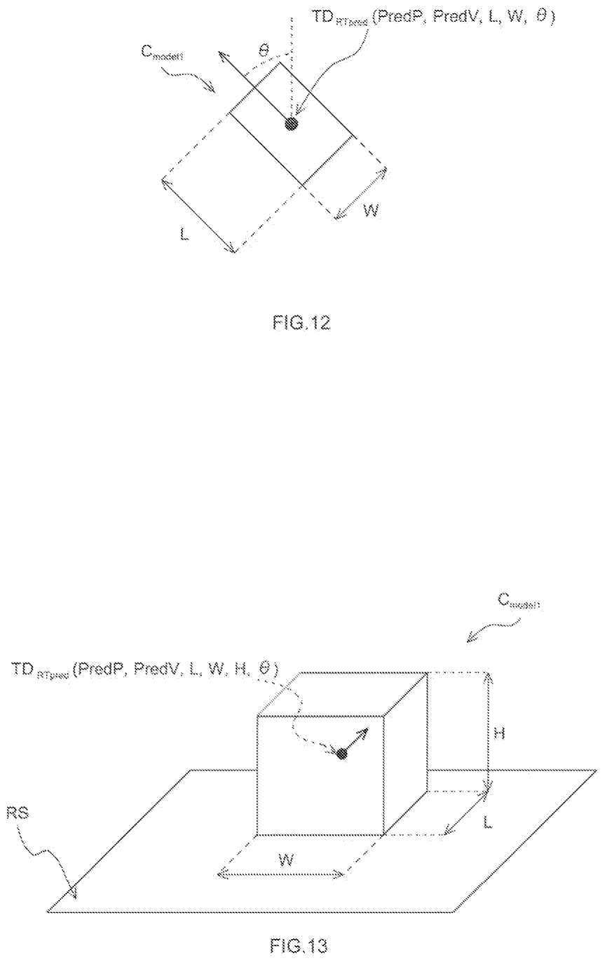

FIG. 12 is a diagram for illustrating an example in which the direction θ is further included in the track data TD of FIG. 7. The width W of the object model C_{model1} is a size of the object model C_{model1} perpendicular to the direction θ of the object model C_{model1}. The length L of the object model C_{model1} is a size of the object model C_{model1} parallel to the direction θ of the object model C_{model1}.

When the direction θ of the object model C_{model1} can be acquired by the measurement principle of the external information sensor 1, the direction θ of the object model C_{model1} is added as an object identification element of the detection data DD. When the direction θ of the object model C_{model1} cannot be acquired by the measurement principle of the external information sensor 1, setting of the direction θ changes in accordance with a ground speed of the object model C_{model1}, that is, the object.

When the ground speed of the object is not zero, the direction θ of the object model C_{model1} is observable as a direction of a ground speed vector, and can thus be acquired. Meanwhile, when the ground speed of the object is zero, that is, the object is a stationary object, an initial angle of 0 (deg) is included in the temporary set data DH as a set value set in advance.

FIG. 13 is a diagram for illustrating an example in which a height H is further included in the track data TD of FIG. 7. It is assumed that the direction θ of the object model C_{model1} is parallel to a road surface RS, and is perpendicular to the height H of the object model C_{model1}.

When the height H of the object model C_{model1} can be acquired by the measurement principle of the external information sensor 1, the height H of the object model C_{model1} is added as an object identification element of the detection data DD. When the height H of the object model C_{model1} cannot be acquired by the measurement principle of the external information sensor 1, an initial height of 1.5 (m) is included in the temporary set data DH as a set value set in advance.

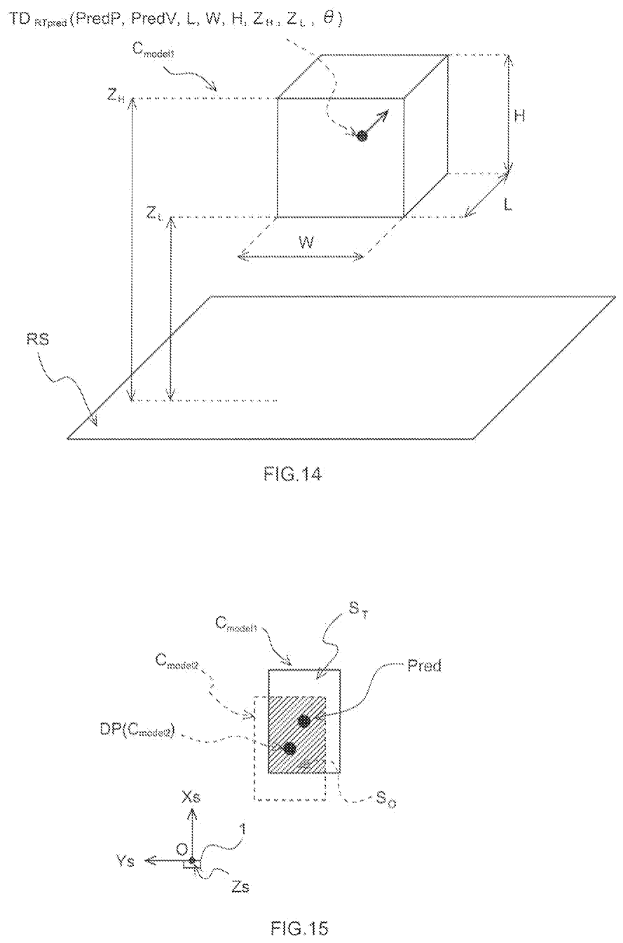

FIG. 14 is a diagram for illustrating an example in which a position of an upper end Z_{H} and a position of a lower end Z_{L} are further included in the track data TD of FIG. 7. It is assumed that “position of upper end Z_{H}≥position of lower end Z_{L}” is satisfied. When the position of the lower end Z_{L} is higher than 0 [m], the object is determined as an object existing above the object, such as a signboard or a traffic sign.

When the position of the upper end Z_{H} and the position of the lower end Z_{L} can be acquired by the measurement principle of the external information sensor 1, the position of the upper end Z_{H} and the position of the lower end Z_{L} are added as detection elements of the detection data DD. When the position of the upper end Z_{H} and the position of the lower end Z_{L} cannot be acquired by the measurement principle of the external information sensor 1, an initial upper end Z_{HDEF} of 1.5 (m) and an initial lower end Z_{LDEF} of 0 (m) are included in the temporary set data DH as set values set in advance.

FIG. 15 is a diagram for schematically illustrating an overlap of a determination target object model C_{model2} being a association determination target having the position P of the detection point DP of FIG. 2 as a center with the object model C_{model1} being the tracking target having the prediction position PredP of FIG. 8 as the center.

As illustrated in FIG. 15, a ratio S₀/ST of an overlap of an area S_{O} of the determination target object model C_{model2} with an area S_{T} of the object model C_{model1} is set to an overlap ratio R. It is evaluated, by using the overlap ratio R and the plurality of reliabilities DOR(N), whether or not the result of determination of whether or not the position P of the detection point DP(C_{model2}) and the prediction position PredP associate with each other is valid.

The determination target object model C_{model2} is generated by modeling the object having the position P of the detection point DP as the center. Meanwhile, the object model C_{model1} is generated by modeling the object having the prediction position PredP as the center as described above.

Specifically, when α and β are coefficients represented by real numbers equal to or larger than 0, and an evaluation value is represented by γ1, an evaluation function is given by Expression (1).

α×(1−R)+β×(1−DOR)=γ1 (1)

Thus, as the overlap ratio R increases, a term including α decreases. Moreover, as the reliability DOR increases, a term including β decreases. Consequently, as the evaluation value γ1 decreases, it can be evaluated that the result of determination of whether or not the position P of the detection point DP (C_{model2}) and the prediction position PredP associate with each other is more valid.

In this case, for example, a association validity flag is set to 1.

Meanwhile, as the evaluation value γ1 increases, it can be evaluated that the result of determination of whether or not the position P of the detection point DP (C_{model2}) and the prediction position PredP associate with each other is less valid.

In this case, for example, the association validity flag is set to 0.

The association validity flag may be set to one of 1 or 0 by setting a threshold value TH1 for the evaluation value γ1.

For example, when the evaluation value γ1 is smaller than the threshold value TH1, the association validity flag is set to 1. Meanwhile, when the evaluation value γ1 is equal to or larger than the threshold value TH1, the association validity flag is set to 0.

In other words, the association processing unit 35 obtains the overlap ratio R of the determination target object model C_{model2} obtained by modeling the object having the position P of the detection point DP as the center to the object model C_{model1} having the prediction position PredP as the center. The association processing unit 35 evaluates, based on the overlap ratio R and the plurality of reliabilities DOR(N), whether or not the result of determination of whether or not the position P of the detection point DP and the prediction position PredP associate with each other is valid.

Description has been given of the example of the evaluation function that uses the overlap ratio R, but the configuration is not limited to this example.

For example, the candidate point DPH having the highest reliability DOR is adopted, and the Euclidean distance du is used for the comparison with the association range RA. When α and β are coefficients represented by real numbers equal to or larger than 0, and an evaluation value is represented by γ2, an evaluation function is given by Expression (2).

α×du+β×(1−DOR)=γ2 (2)

Thus, as the Euclidean distance du decreases, a term including α decreases. Moreover, as the reliability DOR increases, a term including β decreases. Consequently, as the evaluation value γ2 decreases, it can be evaluated that the result of determination of whether or not the position P of the detection point DP(C_{model2}) and the prediction position PredP associate with each other is more valid.

In this case, for example, the association validity flag is set to 1.

Meanwhile, as the evaluation value γ2 increases, it can be evaluated that the result of determination of whether or not the position P of the detection point DP(C_{model2}) and the prediction position PredP associate with each other is less valid.

In this case, for example, the association validity flag is set to 0.

The association validity flag may be set to one of 1 or 0 by setting a threshold value TH2 for the evaluation value γ2.

For example, when the evaluation value γ2 is smaller than the threshold value TH2, the association validity flag is set to 1. Meanwhile, when the evaluation value γ2 is equal to or larger than the threshold value TH2, the association validity flag is set to 0.

Moreover, for example, the candidate point DPH having the highest reliability DOR is adopted, and the Mahalanobis distance dm is used for the comparison with the association range RA. When α and β are coefficients represented by real numbers equal to or larger than 0, and an evaluation value is represented by γ3, an evaluation function is given by Expression (3).

α×dm+β×(1−DOR)=γ3 (3)

Thus, as the Mahalanobis distance dm decreases, a term including α decreases. Moreover, as the reliability DOR increases, a term including β decreases. Consequently, as the evaluation value γ3 decreases, it can be evaluated that the result of determination of whether or not the position P of the detection point DP (C_{model2}) and the prediction position PredP associate with each other is more valid.

In this case, for example, the association validity flag is set to 1.

Meanwhile, as the evaluation value γ3 increases, it can be evaluated that the result of determination of whether or not the position P of the detection point DP(C_{model2}) and the prediction position PredP associate with each other is less valid.

In this case, for example, the association validity flag is set to 0.

The association validity flag may be set to one of 1 or 0 by setting a threshold value TH3 for the evaluation value γ3. For example, when the evaluation value γ3 is smaller than the threshold value TH3, the association validity flag is set to 1. Meanwhile, when the evaluation value γ3 is equal to or larger than the threshold value TH3, the association validity flag is set to 0.

Moreover, for example, there is adopted a candidate point DPH which is calculated by weighted average for each of the positions HP of the plurality of candidate points DPH(N) on the determination target object model C_{model2} in accordance with the respective reliabilities DOR(N), and the Euclidean distance du is used for the comparison with the association range RA. In this case, when α and β are coefficients represented by real numbers equal to or larger than 0, a reliability average value is represented by DORₐᵥᵣ, and an evaluation value is represented by γ4, an evaluation function is given by Expression (4).

α×du+β×(1−DORₐᵥᵣ)=γ4 (4)

Thus, as the Euclidean distance du decreases, a term including α decreases. Moreover, as the reliability average value DORₐᵥᵣ increases, a term including β decreases. Consequently, as the evaluation value γ4 decreases, it can be evaluated that the result of determination of whether or not the position P of the detection point DP(C_{model2}) and the prediction position PredP associate with each other is more valid.

In this case, for example, the association validity flag is set to 1.

Meanwhile, as the evaluation value γ4 increases, it can be evaluated that the result of determination of whether or not the position P of the detection point DP (C_{model2}) and the prediction position PredP associate with each other is less valid.

In this case, for example, the association validity flag is set to 0.

The association validity flag may be set to one of 1 or 0 by setting a threshold value TH4 for the evaluation value γ4. For example, when the evaluation value γ4 is smaller than the threshold value TH4, the association validity flag is set to 1. Meanwhile, when the evaluation value γ4 is equal to or larger than the threshold value TH4, the association validity flag is set to 0.

Moreover, for example, there is adopted a candidate point DPH which is calculated by weighted average for each of the positions HP of the plurality of candidate points DPH(N) on the determination target object model C_{model2} in accordance with the respective reliabilities DOR(N), and the Mahalanobis distance dm is used for the comparison with the association range RA. In this case, when α and β are coefficients represented by real numbers equal to or larger than 0, a reliability average value is represented by DORₐᵥᵣ, and an evaluation value is represented by γ5, an evaluation function is given by Expression (5).

α×dm+β×(1−DORₐᵥᵣ)=γ5 (5)

Thus, as the Mahalanobis distance dm decreases, a term including α decreases. Moreover, as the reliability average value DORₐᵥᵣ increases, a term including β decreases. Consequently, as the evaluation value γ5 decreases, it can be evaluated that the result of determination of whether or not the position P of the detection point DP (C_{model2}) and the prediction position PredP associate with each other is more valid.

In this case, for example, the association validity flag is set to 1.

Meanwhile, as the evaluation value γ5 increases, it can be evaluated that the result of determination of whether or not the position P of the detection point DP (C_{model2}) and the prediction position PredP associate with each other is less valid.

In this case, for example, the association validity flag is set to 0.

The association validity flag may be set to one of 1 or 0 by setting a threshold value TH5 for the evaluation value γ5. For example, when the evaluation value γ5 is smaller than the threshold value TH5, the association validity flag is set to 1. Meanwhile, when the evaluation value γ5 is equal to or larger than the threshold value TH5, the association validity flag is set to 0.

In other words, the association processing unit 35 evaluates, based on one of the Euclidean distance du or the Mahalanobis distance dm and on the plurality of reliabilities DOR(N), whether or not the result of determination of whether or not the position P of the detection point DP and the prediction position PredP associate with each other is valid.

The Euclidean distance du is obtained through use of a difference vector between the position P of the detection point DP and the reference position BP. Meanwhile, the Mahalanobis distance dm is obtained through use of the position P of the detection point DP and the reference position BP.

Moreover, for example, the association processing unit 35 obtains the minimum value of a sum of distances each between each vertex of the object model C_{model1} having the prediction position PredP as the center and each vertex of the determination target object model C_{model2} obtained by modeling the object having the position P of the detection point DP as the center.

The association processing unit 35 evaluates, based on the obtained minimum value and the plurality of reliabilities DOR(N), whether or not the result of determination of whether or not the position P of the detection point DP and the prediction position PredP associate with each other is valid.

Specifically, α and β are coefficients represented by real numbers equal to or larger than 0. Moreover, the minimum value of the sum of the distances each between each vertex of the object model C_{model1} having the prediction position PredP as the center and each vertex of the determination target object model C_{model2} obtained by modeling the object having the position P of the detection point DP as the center is represented by Rm. In this case, when an evaluation value is represented by γ6, an evaluation function is given by Expression (6).

α×Rm+β×(1−DOR)=γ6 (6)

Thus, as the minimum value Rm decreases, a term including α decreases. Moreover, as the reliability DOR increases, a term including β decreases. Consequently, as the evaluation value γ6 decreases, it can be evaluated that the result of determination of whether or not the position P of the detection point DP(C_{model2}) and the prediction position PredP associate with each other is more valid.

In this case, for example, the association validity flag is set to 1.

Meanwhile, as the evaluation value γ6 increases, it can be evaluated that the result of determination of whether or not the position P of the detection point DP(C_{model2}) and the prediction position PredP associate with each other is less valid.

In this case, for example, the association validity flag is set to 0.

The association validity flag may be set to one of 1 or 0 by setting a threshold value TH6 for the evaluation value γ6. For example, when the evaluation value γ6 is smaller than the threshold value TH6, the association validity flag is set to 1. Meanwhile, when the evaluation value γ6 is equal to or larger than the threshold value TH6, the association validity flag is set to 0.

Obtaining the minimum value of the sum of the distances each between each vertex of the object model C_{model1} having the prediction position PredP as the center and each vertex of the determination target object model C_{model2} obtained by modeling the object having the position P of the detection point DP as the center comes down to solving the minimum Steiner tree problem. The minimum Steiner tree problem is the shortest network problem.

Thus, the association processing unit 35 solves the shortest network problem to evaluate whether or not the result of determination of whether or not the position P of the detection point DP (C_{model2}) and the prediction position PredP associate with each other is valid.

Description is now given of processing executed by the object recognition device 3 of FIG. 1.

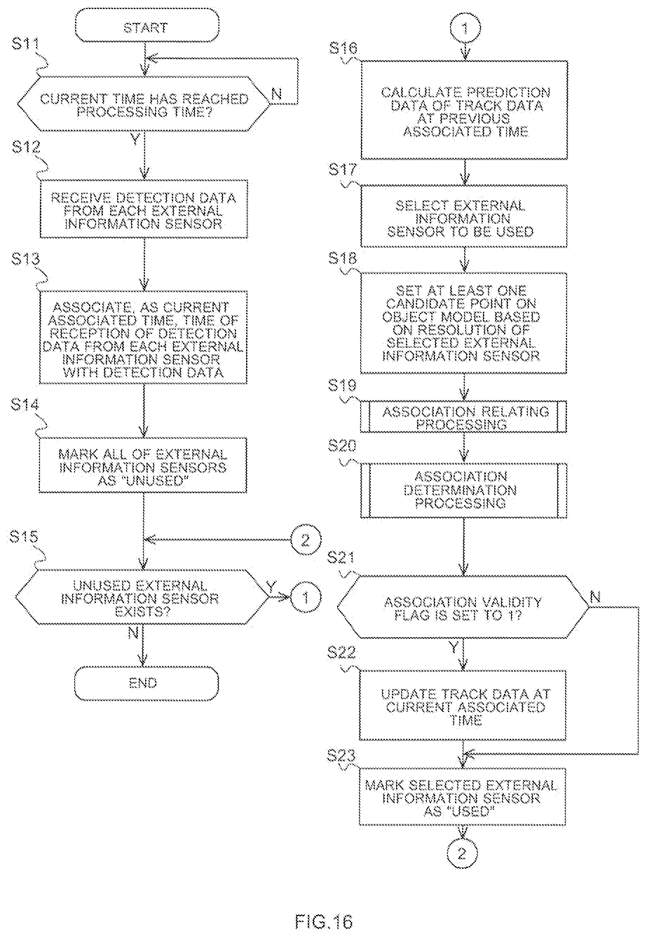

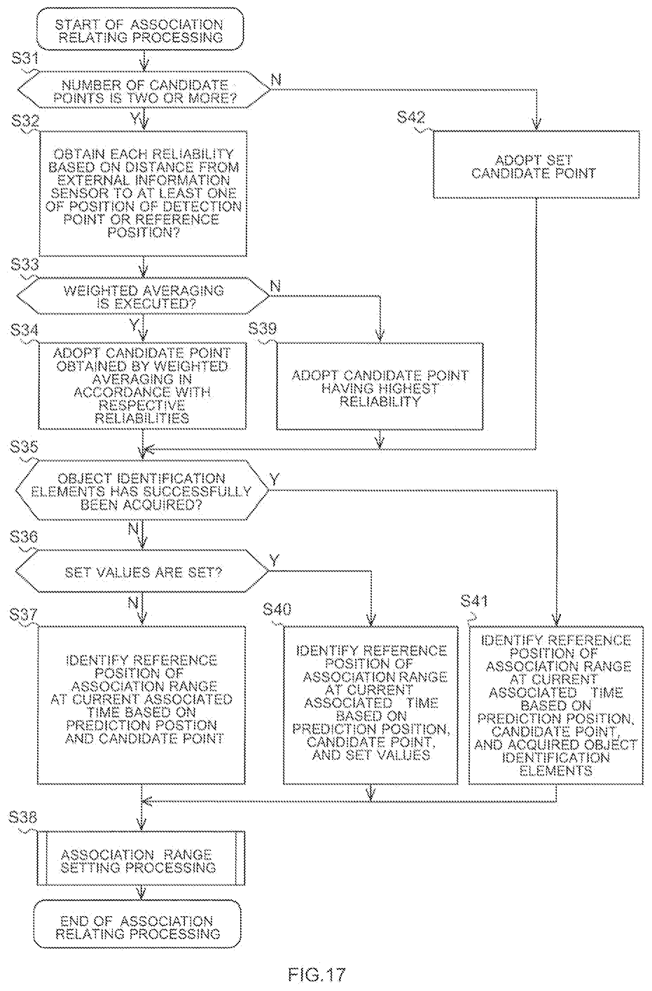

FIG. 16 is a flowchart for illustrating processing executed by the object recognition device 3 of FIG. 1.

In Step S11, the time measurement unit 31 determines whether or not the current time has reached a processing time tk. When the time measurement unit 31 determines that the current time has reached the processing time tk, the process proceeds from Step S11 to Step S12. When the time measurement unit 31 determines that the current time has not reached the processing time tk, the processing step of Step S11 continues.

In Step S12, the data reception unit 32 receives the detection data dd from each external information sensor 1. After that, the process proceeds from Step S12 to Step S13.

In Step S13, the data reception unit 32 associates, as the current associated time RT, a time at which the detection data dd has been received from each external information sensor 1 with the detection data DD. After that, the process proceeds from Step S13 to Step S14.

In Step S14, the data reception unit 32 marks all of the external information sensors 1 as “unused”. After that, the process proceeds from Step S14 to Step S15.

In Step S15, the data reception unit 32 determines whether or not an unused external information sensor 1 exists. When the data reception unit 32 determines that an unused external information sensor 1 exists, the process proceeds from Step S15 to Step S16. When the data reception unit 32 determines that an unused external information sensor 1 does not exist, the process does not proceed from Step S15 to other processing steps, and the processing executed by the object recognition device 3 is finished.

In Step S16, the prediction processing unit 34 calculates the prediction data TD_{RTpred} of the track data TD at the current associated time RT from the track data TD at the previous associated time RT. After that, the process proceeds from Step S16 to Step S17.

In Step S17, the temporary setting unit 33 selects an external information sensor 1 to be used. After that, the process proceeds from Step S17 to Step S18.

In Step S18, the temporary setting unit 33 sets a position HP of at least one candidate point DPH on the object model C_{model1} obtained by modeling an object detected by the selected external information sensor 1 based on the resolution of the selected external information sensor 1. After that, the process proceeds from Step S18 to Step S19.

In Step S19, the association processing unit 35 executes association relating processing described below with reference to FIG. 17. After that, the process proceeds from Step S19 to Step S20.

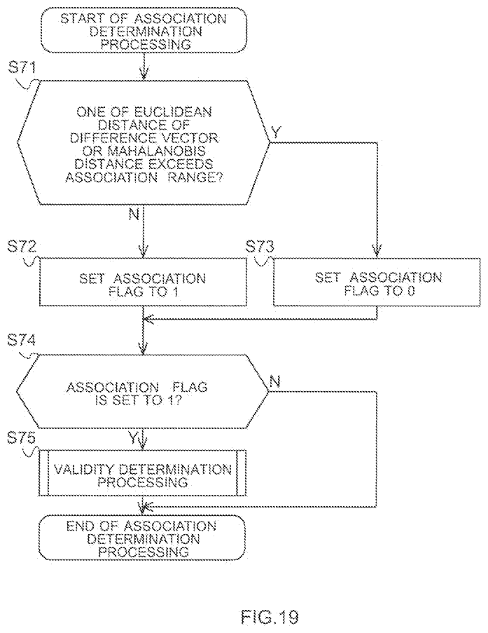

In Step S20, the association processing unit 35 executes association determination processing described below with reference to FIG. 19. After that, the process proceeds from Step S20 to Step S21.

In Step S21, the association processing unit 35 determines whether or not the association validity flag is set to 1. When the association processing unit 35 determines that the association validity flag is set to 1, the process proceeds from Step S21 to Step S22. When the association processing unit 35 determines that the association validity flag is not set to 1, the process proceeds from Step S21 to Step S23.

In Step S22, the update processing unit 36 updates the track data TD at the current associated time RT based on the corrected position P of the detection point DP with respect to the external information sensor 1 at the current associated time RT. After that, the process proceeds from Step S22 to Step S23.

In Step S23, the data reception unit 32 marks the selected external information sensor 1 as “used”. After that, the process proceeds from Step S23 to Step S15.

Description is now given of the association relating processing executed in Step S19 of FIG. 16.

FIG. 17 is a flowchart for illustrating the association relating processing executed in Step S19 of FIG. 16.

In Step S31, the association processing unit 35 determines whether or not the number of candidate points DPH is two or more. When the association processing unit 35 determines that the number of candidate points DPH is two or more, the process proceeds from Step S31 to Step S32.

Meanwhile, when the association processing unit 35 determines that the number of candidate points DPH is not two or more, the process proceeds from Step S31 to Step S42.

In Step S42, the association processing unit 35 adopts the set candidate point DPH. After that, the process proceeds from Step S42 to Step S35.

The process returns to Step S32, and the association processing unit 35 obtains the reliability DOR of each of the plurality of candidate points DPH based on the distance from the selected external information sensor 1 to at least one of the position P of the detection point DP or the reference position BP. After that, the process proceeds from Step S32 to Step S33.

In Step S33, the association processing unit 35 determines whether or not the weighted average is to be executed. When the association processing unit 35 determines to execute the weighted average, the process proceeds from Step S33 to Step S34.

In Step S34, the association processing unit 35 adopts the candidate point DPH which is calculated by weighted average for each of the positions HP of the plurality of candidate points DPH on the object in accordance with the respective reliabilities DOR. After that, the process proceeds from Step S34 to Step S35.

Meanwhile, in Step S33, when the association processing unit 35 determines not to execute the weighted average, the process proceeds from Step S33 to Step S39.

In Step S39, the association processing unit 35 adopts the candidate point DPH having the highest reliability DOR among the positions HP of the plurality of candidate points DPH. After that, the process proceeds from Step S39 to Step S35.

In Step S35, the association processing unit 35 determines whether or not object identification elements have successfully been acquired. When the association processing unit 35 determines that object identification elements have successfully been acquired, the process proceeds from Step S35 to Step S41.

In Step S41, the association processing unit 35 identifies the reference position BP of the association range RA at the current associated time RT based on the prediction position PredP, the candidate point DPH, and the object identification elements that have successfully been acquired from the external information sensors 1. After that, the process proceeds from Step S41 to Step S38.

Meanwhile, in Step S35, when the association processing unit 35 determines that object identification elements have not successfully been acquired, the process proceeds from Step S35 to Step S36.

In Step S36, the association processing unit 35 determines whether or not set values are individually set in advance in correspondence with the object identification elements that cannot be acquired from the external information sensor 1. When the association processing unit 35 determines that set values were individually set in advance in correspondence with the object identification elements that cannot be acquired from the external information sensor 1, the process proceeds from Step S36 to Step S40.

In Step S40, the association processing unit 35 identifies the reference position BP of the association range RA at the current associated time RT based on the prediction position PredP, the candidate point DPH, and the set values individually set in advance in correspondence with the object identification elements that cannot be acquired from the external information sensor 1. After that, the process proceeds from Step S40 to Step S38.

Meanwhile, in Step S36, when the association processing unit 35 determines that set values have not been individually set in advance in correspondence with the object identification elements that cannot to be acquired from the external information sensor 1, the process proceeds from Step S36 to Step S37.

In Step S37, the reference position BP of the association range PA at the current associated time RT is identified based on the prediction position PredP and the candidate point DPH. After that, the process proceeds from Step S37 to Step S38.

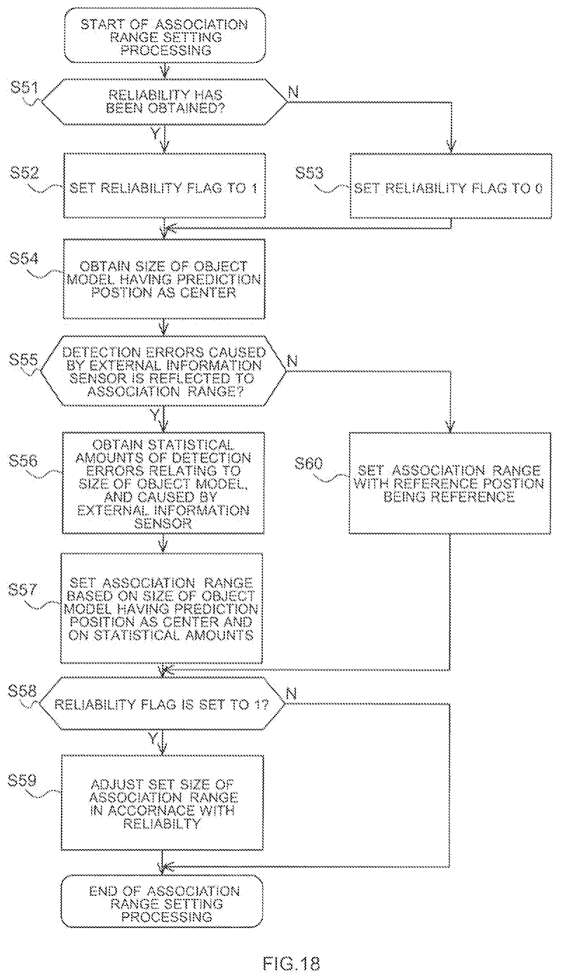

In Step S38, the association processing unit 35 executes association range setting processing described below with reference to FIG. 18. After that, the process does not proceed from Step S38 to other processing steps, and the association relating processing is finished.

Description is now given of the association range setting processing executed in Step S38 of FIG. 17.

FIG. 18 is a flowchart for illustrating the association range setting processing executed in Step S38 of FIG. 17.

In Step S51, the association processing unit 35 determines whether or not the reliability DOR has been obtained. When the association processing unit 35 determines that the reliability DOR has been obtained, the process proceeds from Step S51 to Step S52.

In Step S52, the association processing unit 35 sets a reliability flag to 1. After that, the process proceeds from Step S52 to Step S54.

Meanwhile, in Step S51, when the association processing unit 35 determines that the reliability DOR has not been obtained, the process proceeds from Step S51 to Step S53.

In Step S53, the association processing unit 35 sets the reliability flag to 0. After that, the process proceeds from Step S53 to Step S54.

In Step S54, the association processing unit 35 obtains the size of the object model C_{model1} being the tracking target having the prediction position PredP as the center. After that, the process proceeds from Step S54 to Step S55.

In Step S55, the association processing unit 35 determines whether or not to reflect the detection errors caused by the external information sensor 1 to the association range RA. When the association processing unit 35 determines to reflect the detection errors caused by the external information sensor 1 to the association range RA, the process proceeds from Step S55 to Step 356.

Meanwhile, in Step S55, when the association processing unit 35 determines not to reflect the detection errors caused by the external information sensor 1 to the association range RA, the process proceeds from Step S55 to Step S60.

In Step S60, the association processing unit 35 sets the association range RA so that the association range RA has the reference position BP as the reference. After that, the process proceeds from Step S60 to Step S58.

Back to Step S56, the association processing unit 35 obtains the statistical amounts of the detection errors which relate to the size of the object model C_{model1}, and are caused by the external information sensor 1. After that, the process proceeds from Step S56 to Step S57.

In Step S57, the association processing unit 35 sets the association range RA based on the size of the object model C_{model1} having the prediction position PredP as the center and the statistical amounts. After that, the process proceeds from Step 357 to Step 358.

In Step 358, the association processing unit 35 determines whether or not the reliability flag is set to 1. When the association processing unit 35 determines that the reliability flag is set to 1, the process proceeds from Step S58 to Step S59.

In Step S59, the association processing unit 35 adjusts the set size of the association range RA in accordance with the DOR. After that, the process does not proceed from Step S59 to other processing steps, and the association range setting processing is finished.

Meanwhile, in Step S58, when the association processing unit 35 determines that the reliability flag is not set to 1, the process does not proceed from Step S58 to other processing steps, and the association range setting processing is finished.

Description is now given of the association determination processing executed in Step S20 of FIG. 16.

FIG. 19 is a flowchart for illustrating the association determination processing executed in Step S20 of FIG. 16.

In Step S71, the association processing unit 35 determines whether or not one of the Euclidean distance du of the difference vector between the position P of the detection point DP and the reference position BP or the Mahalanobis distance dm derived based on the position P of the detection point DP and the reference position BP exceeds the association range PA.

When the association processing unit 35 determines that one of the Euclidean distance du or the Mahalanobis distance dm exceeds the association range RA, the process proceeds from Step S71 to Step S73.

In Step S73, the association processing unit 35 sets the reliability flag to 0. After that, the process proceeds from Step S73 to Step S74.

Meanwhile, in Step S71, when the association processing unit 35 determines that one of the Euclidean distance du or the Mahalanobis distance dm does not exceed the association range RA, the process proceeds from Step S71 to Step S72.

In Step 372, the association processing unit 35 sets the reliability flag to 1. After that, the process proceeds from Step S72 to Step S74.

In Step S74, the association processing unit 35 determines whether or not the association flag is set to 1. When the association processing unit 35 determines that the association flag is set to 1, the process proceeds from Step S74 to Step S75.

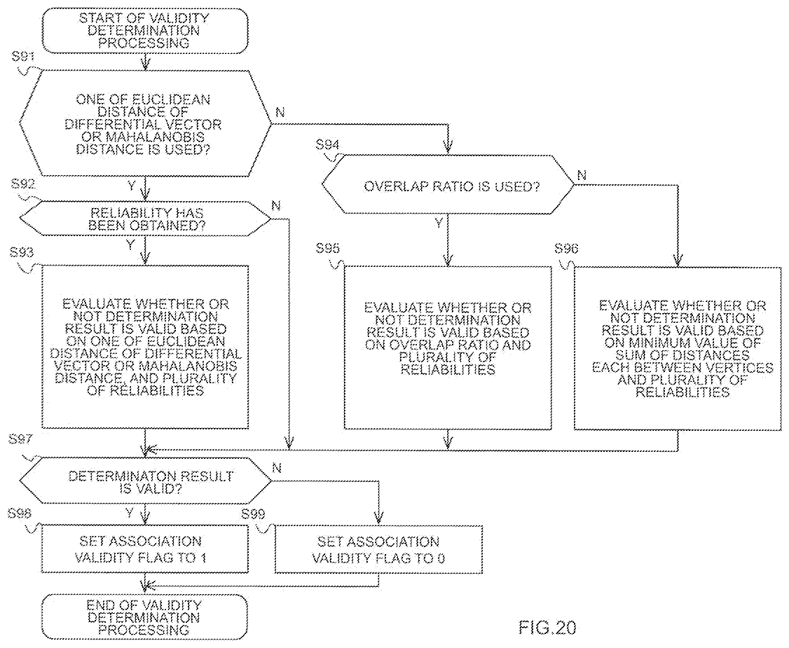

In Step S75, the association processing unit 35 executes validity determination processing described below with reference to FIG. 20. After that, the process does not proceed from Step S75 to other processing steps, and the association determination processing is finished.

Meanwhile, in Step S74, when the association processing unit 35 determines that the association flag is not set to 1, the process does not proceed from Step S74 to other processing steps, and the association determination processing is finished.

Description is now given of the validity determination processing executed in Step S75 of FIG. 19.

FIG. 20 is a flowchart for illustrating the validity determination processing executed in Step S75 of FIG. 19.

In Step S91, the association processing unit 35 determines whether or not one of the Euclidean distance du of the difference vector between the position P of the detection point DP and the reference position BP or the Mahalanobis distance dm derived based on the position P of the detection point DP and the reference position BP is to be used.

When the association processing unit 35 determines that one of the Euclidean distance du or the Mahalanobis distance dm is to be used, the process proceeds from Step S91 to Step S92.

In Step S92, the association processing unit 35 determines whether or not the reliability DOR has been obtained. When the association processing unit 35 determines that the reliability DOR has been obtained, the process proceeds from Step S92 to Step 393.

In Step 393, the association processing unit 35 evaluates, based on one of the Euclidean distance du or the Mahalanobis distance dm and on the plurality of reliabilities DOR(N), whether or not the result of determination of whether or not the position P of the detection point DP and the prediction position PredP associate with each other is valid. After that, the process proceeds from Step S93 to Step S97.

Meanwhile, in Step S91, when it is determined that neither of the Euclidean distance du nor the Mahalanobis distance dm is not to be used, the process proceeds from Step S91 to Step S94.

In Step S94, the association processing unit 35 determines whether or not to use the overlap ratio R of the determination target object model C_{model2} obtained by modeling the object having the position P of the detection point DP as the center to the object model C_{model1} having the prediction position PredP as the center.

When the association processing unit 35 determines to use the overlap ratio R of the determination target object model C_{model2} to the object model C_{model1}, the process proceeds from Step S94 to Step S95.

In Step S95, the association processing unit 35 evaluates, based on the overlap ratio R of the determination target object model C_{model2} to the object model C_{model1} and the plurality of reliabilities DOR(N), whether or not the result of determination of whether or not the position P of the detection point DP and the prediction position PredP associate with each other is valid. After that, the process proceeds from Step S95 to Step S97.

Meanwhile, in Step S94, when the association processing unit 35 determines not to use the overlap ratio R of the determination target object model C_{model2} to the object model C_{model1}, the process proceeds from Step S94 to Step S96.

In Step S96, the association processing unit 35 evaluates, based on the minimum value of the sum of the distances each between each vertex of the object model C_{model1} and each vertex of the determination target object model C_{model2} and the plurality of reliabilities DOR(N), whether or not the result of determination of whether or not the position P of the detection point DP and the prediction position PredP associate with each other is valid. After that, the process proceeds from Step S96 to Step S97.

Meanwhile, in Step S92, when the association processing unit 35 determines that the reliability DOR has not been obtained, the process proceeds from Step S92 to Step S97.

In Step S97, the association processing unit 35 determines whether or not the result of determination of whether or not the position P of the detection point DP and the prediction position PredP associate with each other is valid.

When the association processing unit 35 determines that the result of determination of whether or not the position P of the detection point DP and the prediction position PredP associate with each other is valid, the process proceeds from Step 397 to Step S98.

In Step S98, the association processing unit 35 sets the association validity flag to 1. After that, the process does not proceed from Step S98 to other processing steps, and the validity determination processing is finished.

Meanwhile, in Step S97, when the association processing unit 35 determines that the result of determination of whether or not the position P of the detection point DP and the prediction position PredP associate with each other is not valid, the process proceeds from Step S97 to Step S99.

In Step 399, the association processing unit 35 sets the association validity flag to 0. After that, the process does not proceed from Step S98 to other processing steps, and the validity determination processing is finished.

As described above, the association processing unit 35 identifies the reference position BP on the object model C_{model1} based on the position HP of the candidate point DPH and the prediction position PredP.

The association processing unit 35 determines whether or not the position P of the detection point DP and the prediction position PredP associate with each other based on the positional relationship between the association range RA and the detection point DP. In this case, the association range RA is set such that the association range RA has the reference position BP as the reference. The detection point DP is the detection point DP at the time when the external information sensor 1 has detected at least one object of a plurality of objects.

Specifically, the object model C_{model1} is the model obtained by modeling the object. As to the prediction position PredP, the position of the movement destination of the object is predicted as the position of the movement destination on the object model C_{model1}. Thus, the resolution of the external information sensor 1 is not reflected to the prediction position PredP.

As described above, the external information sensor 1 has the resolution that varies depending on the measurement principle of the external information sensor 1. Thus, the temporary setting unit 33 sets at least one position HP of the candidate point DPH on the object model C_{model1} based on the resolution of the external information sensor 1. Consequently, the resolution of the external information sensor 1 is reflected to the position HP of the candidate point DPH.

Further, the association processing unit 35 identifies the reference position BP on the object model C_{model1} based on the position HP of the candidate point DPH and the prediction position PredP. Consequently, the resolution of the external information sensor 1 is also reflected to the reference position BP of the object model C_{model1}. Thus, the resolution of the external information sensor 1 is also reflected to the association range RA set so that the association range RA has the reference position BP as the reference.

Further, the association processing unit 35 uses the association range RA for the determination processing of whether or not the position P of the detection point DP and the prediction position PredP associate with each other.

Consequently, the result of the determination processing of whether or not the position P of the detection point DP and the prediction position PredP associate with each other is a result obtained in consideration of deviation caused by the resolution of the external information sensor 1. As a result, the association range RA set so that the association range RA has the reference position BP as the reference is obtained in consideration of the deviation caused by the resolution of the external information sensor 1. Thus, when it is determined whether or not the association range RA and the position P of the detection point DP associate with each other, the determination result is obtained in consideration of the deviation caused by the resolution of the external information sensor 1. Consequently, it is possible to suppress occurrence of erroneous determination of the association between the association range RA and the position P of the detection point DP, and thus the precision of the track data TD on the object can be increased.

The association processing unit 35 identifies the reference position BP on the object model C_{model1} based on an object identification element that identifies at least one of the state or the size of the object model C_{model1}. The positional relationship among the position HP of the candidate point DPH, the prediction position PredP, and the object model C_{model1} becomes clear through use of the object identification element. Thus, the positional relationship between the object model C_{model1} and the reference position BP becomes clear. Consequently, it is possible to accurately identify the reference position BP on the object model C_{model1}.

Moreover, the association processing unit 35 may not be able to acquire, as an object identification element, at least one of the width W or the length L of the object model C_{model1} from the external information sensor 1. In this case, the association processing unit 35 identifies a set value that corresponds to the object identification element that cannot be acquired from the external information sensor 1, among the set values set in advance individually in correspondence with the width W and the length L of the object model C_{model1}. The association processing unit 35 identifies the value of the object identification element that cannot be acquired from the external information sensor 1 based on the identified set value.

Thus, even when at least one of the width W or the length L of the object model C_{model1} cannot be acquired from the external information sensor 1, the track data TD can be updated while suppressing error. Consequently, the relative positional relationship between the own vehicle and the object is not greatly different from the relative positional relationship, and thus a decrease in precision of automatic driving of the own vehicle can be suppressed to the minimum level.

Moreover, the association processing unit 35 may not be able to acquire, as an object identification element, at least one of the width W, the length L, or the direction θ of the object model C_{model1} from the external information sensor 1. In this case, the association processing unit 35 identifies a set value that corresponds to the object identification element that cannot be acquired from the external information sensor 1, among the set values set in advance individually in correspondence with the width W, the length L, and the direction θ of the object model C_{model1}. The association processing unit 35 identifies the value of the object identification element that cannot be acquired from the external information sensor 1 based on the identified set value.

Thus, even when at least one of the width W, the length L, or the direction θ of the object model C_{model1} cannot be acquired from the external information sensor 1, the track data TD can be updated while suppressing error. Consequently, the relative positional relationship between the own vehicle and the object is not greatly different from the relative positional relationship, and thus a decrease in precision of automatic driving of the own vehicle can be suppressed to the minimum level.

Moreover, the association processing unit 35 may not be able to acquire, as an object identification element, at least one of the width W, the length L, the direction θ, or the height H of the object model C_{model1} from the external information sensor 1. In this case, the association processing unit 35 identifies a set value that corresponds to the object identification element that cannot be acquired from the external information sensor 1, among the set values set in advance individually in correspondence with the width W, the length L, the direction θ, and the height H of the object model C_{model1}. The association processing unit 35 identifies the value of the object identification element that cannot be acquired from the external information sensor 1 based on the identified set value.

Thus, even when at least one of the width W, the length L, the direction θ, or the height H of the object cannot be acquired from the external information sensor 1, the track data TD can be updated while suppressing error. Consequently, the relative positional relationship between the own vehicle and the object is not greatly different from the relative positional relationship, and thus a decrease in precision of automatic driving of the own vehicle can be suppressed to the minimum level.

Moreover, the association processing unit 35 may not be able to acquire, as an object identification element, at least one of the width W, the length L, the direction θ, the position of the upper end Z_{H}, or the position of the lower end Z_{L} of the object model C_{model1} from the external information sensor 1. In this case, the association processing unit 35 identifies a set value that corresponds to the object identification element that cannot be acquired from the external information sensor 1, among the set values set in advance individually in correspondence with the width W, the length L, the direction θ, the position of the upper end Z_{H}, and the position of the lower end Z_{L} of the object model C_{model1}. The association processing unit 35 identifies the value of the object identification element that cannot be acquired from the external information sensor 1 based on the identified set value.

Thus, even when at least one of the width W, the length L, the direction θ, the position of the upper end Z_{H}, or the position of the lower end Z_{L} of the object model C_{model1} cannot be acquired from the external information sensor 1, the track data TD can be updated while suppressing error. Consequently, the relative positional relationship between the own vehicle and the object is not greatly different from the relative positional relationship, and thus a decrease in precision of automatic driving of the own vehicle can be suppressed to the minimum level.

Moreover, when the position of the upper end Z_{H} and the position of the lower end Z_{L} of the object model C_{model1} are also corrected in addition to the width W, the length L, and the direction θ of the object, it is possible to identify whether or not the object is a stationary object. The stationary object is, for example, a signboard. The stationary object may be a traffic sign. Thus, the type of the object can be identified. Consequently, the precision of the automatic driving of the own vehicle can further be increased.

Moreover, the association processing unit 35 may have a plurality of candidate points DPH for one detection point DP. In this case, the association processing unit 35 identifies the reference position BP on the object model C_{model1} based on the respective reliabilities DOR of the plurality of candidate points DPH and the respective positions HP of the plurality of candidate points DPH on the object model C_{model1}.

Thus, the reference position BP on the object model C_{model1} is identified also in consideration of the reliability DOR of the positions HP of the candidate points DPH. Consequently, each of the plurality of candidate points DPH can effectively be used.

Moreover, the association processing unit 35 identifies the reference position BP on the object model C_{model1} based on the position HP of the candidate point DPH that has the highest reliability DOR among the positions HP of the plurality of candidate points DPH on the object model C_{model1}.

When there are a plurality of candidate points DPH on one object model C_{model1}, the respective set precisions of the positions HP of the plurality of candidate points DPH on the one object model C_{model1} may be different from one another. Thus, the association processing unit 35 identifies the reference position BP on the object model C_{model1} based on the position HP of the candidate point DPH that has the highest reliability DOR among the positions HP of the plurality of candidate points DPH on the one object model C_{model1}. Thus, the position HP of the candidate point DPH having the highest set precision on the one object model C_{model1} can be used. Consequently, it is possible to use the position HP of the candidate point DPH that has the highest set precision among the positions HP of the plurality of candidate points DPH on the one object model C_{model1} set based on the resolution of the same external information sensor 1.

Moreover, the association processing unit 35 identifies the reference position BP on one object model C_{model1} by averaging the respective positions HP of the plurality of candidate points DPH on the one object model C_{model1} which are weighted in accordance with the respective reliabilities DOR.

When there are a plurality of candidate points DPH on one object model C_{model1}, the respective set precisions of the positions HP of the plurality of candidate points DPH on the one object model C_{model1} are different from one another. Thus, the association processing unit 35 identifies the reference position BP on the one object model C_{model1} by calculated by weighted average for each of the positions HP of the plurality of candidate points DPH on the one object model C_{model1}. After influence of candidate points DPH that have a low reliability DOR is reduced and influence of candidate points DPH that have a high reliability DOR is increased among the plurality of candidate points DPH on the one object model C_{model1}, the reference position BP on the object model C_{model1} s identified. Consequently, after there are reflected the respective reliabilities DOR that are set to the positions HP of the plurality of candidate points DPH on the one object set based on the resolution of the same external information sensor 1, the reference position BP on the object model C_{model1} can be identified.

Moreover, the association processing unit 35 obtains each reliability DOR based on the distance from the external information sensor 1 to at least one of the position P of the detection point DP or the reference position BP.

The resolution of the external information sensor 1 is the resolution that changes depending on the distance from the external information sensor 1 to one of the position P of the detection point DP or the reference position BP. For example, in a case in which the external information sensor 1 is formed of the millimeter wave radar, when the distance to the position P of the detection point DP is short, the detection point DP is highly likely to be the closest point. Meanwhile, when the distance to the position P of the detection point DP is long, the detection point DP is buried in the resolution cell. Thus, the detection point DP is assumed to be a reflection point reflected at the center of an object. The same applies to the reference position BP as to the detection point DP. Thus, the association processing unit 35 obtains each reliability based on the distance from the external information sensor 1 to at least one of the position P of the detection point DP or the reference position BP. Consequently, the reliability DOR can be obtained based on the performance of the external information sensor 1.

Moreover, the association processing unit 35 sets the association range RA based on the size of the object model C_{model1} having the prediction position PredP as the center and the statistical amounts of the detection errors which relate to the size of the object model C_{model1}, and are caused by the external information sensor 1.

Thus, the information on the size of the object model C_{model1} is reflected to the association range RA. Consequently, erroneous association to an object having a different size can be excluded.

Moreover, the association processing unit 35 sets the size of the association range RA based on the size of the object model C_{model1} having the prediction position PredP as the center and the statistical amounts of the detection errors which relate to the size of the object model C_{model1}, and are caused by the external information sensor 1. The association processing unit 35 adjusts the size of the set association range RA in accordance with the plurality of reliabilities DOR(N).

For example, as described above with reference to FIG. 6, 0 is set to the reliability DOR(1) when the distance is equal to or longer than the determination threshold distance D_{TH2}. In this case, the reliability DOR(1) is low, and the detection errors are thus large. When the detection errors are large, the position P of the detection point DP that is to be actually included in the association range RA deviates from the association range RA. Thus, when the detection errors are considered, it is required to extend the association range RA. With this configuration, the position P of the detection point DP that deviates from the association range RA due to the detection errors can be included in the association range RA.

Meanwhile, the reliability DOR(1) is set to 1 when the distance is shorter than the determination threshold distance D_{TH1}. In this case, the reliability DOR(1) is high, and the detection errors are thus small. When the detection errors are small, the position P of the detection point DP that is estimated to be included in the association range RA does not deviate from the association range RA. Thus, when the detection errors are considered, the association range PA may be narrowed more or less. With this configuration, it is possible to more accurately determine whether or not the position P of the detection point DP and the prediction position PredP associate with each other.

Moreover, the association processing unit 35 determines whether or not the position P of the detection point DP and the prediction position PredP associate with each other based on whether or not one of the Euclidean distance du or the Mahalanobis distance dm exceeds the association range RA. The Euclidean distance du is obtained through use of the difference vector between the position P of the detection point DP and the reference position BP. Meanwhile, the Mahalanobis distance dm is obtained through use of the position P of the detection point DP and the reference position BP.

Thus, it is determined whether or not the position P of the detection point DP and the prediction position PredP associate with each other through use of the simple index such as the Euclidean distance du and the Mahalanobis distance dm. It is thus possible to increase the precision of the determination of whether or not the position P of the detection point DP and the prediction position PredP associate with each other.

Moreover, the association processing unit 35 evaluates, based on one of the Euclidean distance du or the Mahalanobis distance dm and on the plurality of reliabilities DOR(N), whether or not the result of determination of whether or not the position P of the detection point DP and the prediction position PredP associate with each other is valid. The Euclidean distance du is obtained through use of the difference vector between the position P of the detection point DP and the reference position BP. Further, the Mahalanobis distance dm is obtained through use of the position P of the detection point DP and the reference position BP.

Thus, the validity of the result of determination of whether or not the position P of the detection point DP and the prediction position PredP associate with each other is evaluated while the reliability of the result of the determination that is not made in accordance with only the index such as the Euclidean distance du and Mahalanobis distance dm is included. Consequently, it is possible to exclude the error in the determination of whether or not the position P of the detection point DP and the prediction position PredP associate with each other.

Moreover, the association processing unit 35 evaluates, based on the overlap ratio R of the determination target object model C_{model2} to the object model C_{model1} and the plurality of reliabilities DOR(N), whether or not the result of determination of whether or not the position P of the detection point DP and the prediction position PredP associate with each other is valid. In this case, the object model C_{model1} has the prediction position PredP as the center. Moreover, the determination target object model C_{model2} is generated by modeling the object having the position P of the detection point DP as the center.

The overlap ratio R becomes higher when the own vehicle and an object are moving in the same direction compared with the case in which the own vehicle and the object are moving in directions different from each other. Thus, it is possible to exclude an object for which the determination of the association is likely to be unnecessary in the future by evaluating whether or not the result of determination of whether or not the position P of the detection point DP and the prediction position PredP associate with each other is valid in consideration of the overlap ratio R.

Moreover, the association processing unit 35 evaluates, based on the minimum value of the sum of the distances each between each vertex of the object model C_{model1} and each vertex of the determination target object model C_{model2} and the plurality of reliabilities DOR(N), whether or not the result of determination of whether or not the position P of the detection point DP and the prediction position PredP associate with each other is valid. In this case, the object model C_{model1} has the prediction position PredP as the center. Moreover, the determination target object model C_{model2} is generated by modeling the object having the position P of the detection point DP as the center.

Obtaining the minimum value of the sum of the distances each between each vertex of the object model C_{model1} having the prediction position PredP as the center and each vertex of the determination target object model C_{model2} having the position P of the detection point DP as the center comes down to solving the minimum Steiner tree problem. The minimum Steiner tree problem is the shortest network problem. Thus, the association processing unit 35 solves the shortest network problem and further uses the reliability DOR as well to evaluate whether or not the result of determination of whether or not the position P of the detection point DP and the prediction position PredP associate with each other is valid. Consequently, it is possible to more accurately determine the validity of the result of determination of whether or not the position P of the detection point DP and the prediction position PredP associate with each other.

Moreover, each embodiment includes a processing circuit for implementing the object recognition device 3. The processing circuit may be dedicated hardware or a CPU (central processing unit, also referred to as processing unit, calculation device, microprocessor, microcomputer, processor, or DSP) for executing programs stored in a memory.

FIG. 21 is a diagram for illustrating a hardware configuration example. In FIG. 21, a processing circuit 201 is connected to a bus 202. When the processing circuit 201 is dedicated hardware, for example, a single circuit, a complex circuit, a programmed processor, an ASIC, an FPGA, or a combination thereof corresponds to the processing circuit 201. Each of the functions of the respective units of the object recognition device 3 may be implemented by the processing circuit 201, or the functions of the respective units may be collectively implemented by the processing circuit 201.

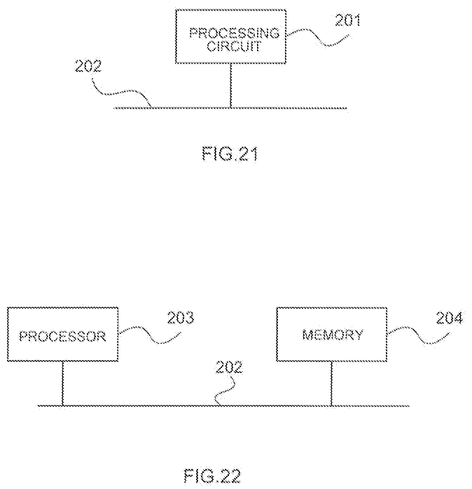

FIG. 22 is a diagram for illustrating another hardware configuration example. In FIG. 22, a processor 203 and a memory 204 are connected to a bus 202. When the processing circuit is a CPU, the functions of the respective units of the object recognition device 3 are implemented by software, firmware, or a combination of software and firmware. The software or the firmware is described as programs, and is stored in the memory 204. The processing circuit reads out and executes the programs stored in the memory 204, to thereby implement the functions of the respective units. That is, the object recognition device 3 includes the memory 204 for storing the programs which consequently execute steps of controlling the time measurement unit 31, the data reception unit 32, the temporary setting unit 33, the prediction processing unit 34, the association processing unit 35, and the update processing unit 36 when the programs are executed by the processing circuit. Moreover, it can be considered that those programs cause the computer to execute procedures or methods of executing the time measurement unit 31, the data reception unit 32, the temporary setting unit 33, the prediction processing unit 34, the association processing unit 35, and the update processing unit 36. In this configuration, a nonvolatile or volatile semiconductor memory such as a RAM, a ROM, a flash memory, an EPROM, an EEPROM, and the like, a magnetic disk, a flexible disk, an optical disc, a compact disc, a MiniDisc, a DVD, and the like correspond to the memory 204.

A part of the functions of the respective units of the object recognition device 3 may be implemented by dedicated hardware, and a remaining part thereof may be implemented by software or firmware. For example, the function of the temporary setting unit 33 can be implemented by a processing circuit as the dedicated hardware. Moreover, the function of the association processing unit 35 can be implemented by a processing circuit reading out and executing the program stored in the memory 204.

As described above, the processing circuit can implement each of the above-mentioned functions by hardware, software, firmware, or a combination thereof.

In the first embodiment, description is given of the example of the processing of determining whether or not the detection data DD_{RT} and the prediction data TD_{RTpred} of the track data TD_{RT} associate with each other through use of the SNN algorithm, the GNN algorithm, the JPDA algorithm, or the like, but the configuration is not limited to this example.

For example, whether or not the detection data DD_{RT} and the prediction data TD_{RTpred} associate with each other may be determined based on whether or not a difference between each detection element and each track element is within an error amount “e” defined in advance. In this case, each detection element is included in the detection data DD_{RT}. Moreover, each track element is included in the prediction data TD_{RTpred}.

Specifically, the association processing unit 35 derives a distance difference between the position P with respect to the external information sensor 1 included in the detection data DD_{RT} and the position P included in the prediction data TD_{RTpred} of the track data TD_{RT}.

The association processing unit 35 derives a speed difference between the speed V included in the detection data DD_{RT} and the speed V included in the prediction data TD_{RTpred} of the track data TD_{RT}.

The association processing unit 35 derives an azimuth angle difference between the azimuth angle included in the detection data DD_{RT} and the azimuth angle included in the prediction data TD_{RTpred} of the track data TD_{RT}.

The association processing unit 35 obtains a square root of a sum of squares of the distance difference, the speed difference, and the azimuth angle difference. When the obtained square root exceeds the error amount “e”, the association processing unit 35 determines that the detection data DD_{RT} and the prediction data TD_{RTpred} do not associate with each other. When the obtained square root is equal to or less than the error amount “e”, the association processing unit 35 determines that the detection data DD_{RT} and the prediction data TD_{RTpred} associate with each other. Through this determination processing, whether or not the detection data DD_{RT} and the prediction data TD_{RTped} of the track data TD_{RT} associate with each other may be determined.

Moreover, for example, the ground speed at the detection point DP may be obtained based on the speed V of the detection point DP. There is a case in which the ground speed at the detection point DP is obtained.

In this case, when the object detected by the external information sensor 1 has been determined to be the vehicle C based on the ground speed at the detection point DP, the object identification elements of the detection data DD may not include the width W and the length L of the vehicle C.

In this case, the width W of the vehicle C is set to 2 (m), and the length L of the vehicle C is set to 4.5 (m). The width W and the length L of the vehicle C set in this manner are also set values individually set in advance in correspondence with the object identification elements that cannot be acquired from the external information sensor 1.

The update processing unit 36 may update the track data TD based on the speed V of the detection point DP at the time when the object was detected by the external information sensor 1. Consequently, the track data TD can be updated based on the speed V of the detection point DP in consideration of the observation result observed by the external information sensor 1. As a result, the relative positional relationship between the own vehicle and the object can accurately be recognized, and the precision of the automatic driving of the own vehicle can thus further be increased.

### REFERENCE SIGNS LIST

1 external information sensor, 2 vehicle information sensor, 3 object recognition device, 4 notification control device, 5 vehicle control device, 31 time measurement unit, 32 data reception unit, 33 temporary setting unit, 34 prediction processing unit, 35 association processing unit, 36 update processing unit

1: An object recognition device, comprising:
a prediction processing unit configured to predict, as a prediction position on an object model obtained by modeling a tracking target, a position of a movement destination of the tracking target based on a trajectory formed by movement of at least one object of a plurality of objects as the tracking target;
a temporary setting unit configured to set, based on specifications of a sensor that has detected the tracking target, a position of at least one candidate point on the object model; and
a association processing unit configured to identify a reference position on the object model based on the position of the at least one candidate point and the prediction position, and to determine, based on a positional relationship between a association range which is set so that the association range has the reference position on the object model as a reference and a detection point at a time when the sensor has detected the at least one object of the plurality of objects, whether the position of the detection point and the prediction position associate with each other.

2: The object recognition device according to claim 1, wherein the association processing unit is configured to identify the reference position on the object model based on an object identification element that identifies at least one of a state or a size of the object model.

3: The object recognition device according to claim 2, wherein the association processing unit is configured to identify, when at least one of a width or a length of the object model is unavailable from the sensor as the object identification element, a value of the object identification element unavailable from the sensor based on, among set values individually set in advance in correspondence with the width and the length of the object model, the set value corresponding to the object identification element unavailable from the sensor.

4: The object recognition device according to claim 2, wherein the association processing unit is configured to identify, when at least one of a width, a length, or a direction of the object model is unavailable from the sensor as the object identification element, a value of the object identification element unavailable from the sensor based on, among set values individually set in advance in correspondence with the width, the length, and the direction of the object model, the set value corresponding to the object identification element unavailable from the sensor.

5: The object recognition device according to claim 2, wherein the association processing unit is configured to identify, when at least one of a width, a length, a direction, or a height of the object model is unavailable from the sensor as the object identification element, a value of the object identification element unavailable from the sensor based on, among set values individually set in advance in correspondence with the width, the length, the direction, and the height of the object model, the set value corresponding to the object identification element unavailable from the sensor.

6: The object recognition device according to claim 2, wherein the association processing unit is configured to identify, when at least one of a width, a length, a direction, a position of an upper end, or a position of a lower end of the object model is unavailable from the sensor as the object identification element, a value of the object identification element unavailable from the sensor based on, among set values individually set in advance in correspondence with the width, the length, the direction, the position of the upper end, and the position of the lower end of the object model, the set value corresponding to the object identification element unavailable from the sensor.

7: The object recognition device according to claim 1, wherein, when the number of candidate points is two or more, the association processing unit is configured to identify the reference position on the object model based on a reliability of each of the plurality of candidate points and a position of each of the plurality of candidate points on the object model.

8: The object recognition device according to claim 7, wherein the association processing unit is configured to identify the reference position on the object model based on a position of a candidate point that has the highest reliability, among the positions of the plurality of candidate points on the object model.

9: The object recognition device according to claim 7, wherein the association processing unit is configured to identify the reference position on the object model by averaging the respective positions of the plurality of candidate points on the object model, which are weighted in accordance with the respective reliabilities.

10: The object recognition device according to claim 7, wherein the association processing unit is configured to obtain each reliability based on a distance from the sensor to at least one of the position of the detection point or the reference position.

11: The object recognition device according to claim 7, wherein the association processing unit is configured to set the association range based on a size of the object model having the prediction position as a center and a statistical amount of a detection error which relates to the size of the object model, and is caused by the sensor.

12: The object recognition device according to claim 7, wherein the association processing unit is configured to adjust, in accordance with the plurality of reliabilities, a size of the association range which is set based on a size of the object model having the prediction position as a center and a statistical amount of a detection error which relates to the size of the object model, and is caused by the sensor.

13: The object recognition device according to claim 11, wherein the association processing unit is configured to determine whether the position of the detection point and the prediction position associate with each other based on whether the association range is exceeded by one of a Euclidean distance of a difference vector between the position of the detection point and the reference position or a Mahalanobis distance derived based on the position of the detection point and the reference position.

14: The object recognition device according to claim 13, wherein the association processing unit is configured to evaluate whether a result of the determination of whether the position of the detection point and the prediction position associate with each other is valid based on one of the Euclidean distance or the Mahalanobis distance and on the plurality of reliabilities.

15: The object recognition device according to claim 13, wherein the association processing unit is configured to evaluate whether a result of the determination of whether the position of the detection point and the prediction position associate with each other is valid based on an overlap ratio of a determination target object model obtained by modeling the at least one object having the position of the detection point as a center to the object model having the prediction position as the center, and on the plurality of reliabilities.

16: The object recognition device according to claim 13, wherein the association processing unit is configured to evaluate whether a result of the determination of whether the position of the detection point and the prediction position associate with each other is valid based on a minimum value of a sum of distances each between each vertex of the object model having the prediction position as the center and each vertex of a determination target object model obtained by modeling the at least one object having the position of the detection point as a center, and on the plurality of reliabilities.

17: An object recognition method, comprising the steps of:
predicting, as a prediction position on an object model obtained by modeling a tracking target, a position of a movement destination of the tracking target based on a trajectory formed by movement of at least one object of a plurality of objects as the tracking target;
setting, based on specifications of a sensor that has detected the tracking target, a position of at least one candidate point on the object model; and
identifying a reference position on the object model based on the position of the at least one candidate point and the prediction position, and determining, based on a positional relationship between a association range which is set so that the association range has the reference position on the object model as a reference and a detection point at a time when the sensor has detected the at least one object of the plurality of objects, whether the position of the detection point and the prediction position associate with each other.
